(19) United States
(12) Patent Application Publication
(10) Pub. No.: US 2025/0192661 A1
(43) Pub. Date: Jun. 12, 2025

(54) MULTI-PHASE SWITCHING POWER CONVERTERS WITH LOW MAGNETIC CORE LOSSES, AND ASSOCIATED METHODS

(71) Applicant: Maxim Integrated Products, Inc., San Jose, CA (US)

(72) Inventors: Alexandr Ikriannikov, San Jose, CA (US); Thurein Soe Paing, Lafayette, CO (US)

(21) Appl. No.: 18/966,358

(22) Filed: Dec. 3, 2024

Related U.S. Application Data
(60) Provisional application No. 63/609,226, filed on Dec. 12, 2023.

(51) Int. Cl. H02M 1/00; H01F 27/24; H01F 27/28; H02M 1/08; H02M 3/00; H02M 3/158

(52) U.S. Cl. CPC H02M 1/0048; H01F 27/24; H01F 27/2804; H02M 1/08; H02M 3/003; H02M 3/158

(57) ABSTRACT

A method for reducing magnetic core losses in a multi-phase switching power converter including a coupled inductor. The method includes (a) generating a plurality of periodic voltage waveforms, each periodic voltage waveform being applied across a respective winding of a plurality of windings of the coupled inductor, and (b) distributing flow of changing magnetic flux in a magnetic core of the coupled inductor by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other.

### RELATED APPLICATIONS

This application claims benefit of U.S. Provisional Patent Application No. 63/609,226, filed on Dec. 12, 2023, which is incorporate herein by reference.

### BACKGROUND

Switching power converters are widely used in electronic devices, such as to provide a regulated electric power source. A switching power converter is configured such that its solid-state power switching devices do not continuously operate in their active states; instead, the power switching devices repeatedly switch between their on-states and off-states. Although switching power converters can achieve high efficiency, particularly under heavy load conditions, they exhibit losses from switching devices repeatedly switching between their on-states and off-states. Such losses, which may be referred to as switching losses, include losses in switching devices as well as losses in other components, such as inductors and capacitors, electrically coupled to the switching devices.

Inductors are commonly used for energy storage in switching power converters. Some switching power converters include one or more discrete inductors, where a discrete inductor is an inductor that is not magnetically coupled to any other inductor. Other switching power converters include one or more coupled inductors, where a coupled inductor is a device including two or more inductors that are magnetically coupled. A coupled inductor exhibits magnetizing or mutual inductance, which is inductance associated with magnetic flux linking the windings of the coupled inductor. Additionally, each winding of a coupled inductor exhibits leakage inductance, which is inductance associated with magnetic flux that flows only around the particular winding, i.e., magnetic flux that does not couple to any other winding. Coupled inductors are frequently used in multi-phase switching power converters, such as in a multi-phase buck converter, a multi-phase boost converter, or a multi-phase buck-boost converter, for energy storage and to achieve advantageous coupling of the converter phases.

### BRIEF DESCRIPTION OF THE DRAWINGS

FIG. 1 is an illustration of a discrete inductor showing magnetic flux flowing through a magnetic core of the discrete inductor.

FIG. 2 is an illustration of a coupled inductor showing magnetic flux flowing through a magnetic core of the coupled inductor.

FIG. 3 is a schematic diagram of a multi-phase switching power converter with low magnetic core losses, according to an embodiment.

FIG. 4 illustrates one possible implementation of switching stages of the FIG. 3 multi-phase switching power converter.

FIG. 5 is a top plan view of one possible embodiment of a coupled inductor of the FIG. 3 multi-phase switching power converter.

FIG. 6 is a cross-sectional view of the FIG. 5 coupled inductor taken along line 6A-6A of FIG. 5.

FIG. 7 is a side elevational view of the FIG. 5 coupled inductor.

FIG. 8 is a cross-sectional view of the FIG. 5 coupled inductor taken along line 8A-8A of FIG. 6.

FIG. 9 is a schematic diagram of an alternate embodiment of the FIG. 3 multi-phase switching power converter including a coupled inductor with windings disposed in two rows.

FIG. 10 is a top plan view of one possible embodiment of a coupled inductor of the FIG. 9 multi-phase switching power converter.

FIG. 11 is a front elevational view of the FIG. 10 coupled inductor.

FIG. 12 is a side elevational view of the FIG. 10 coupled inductor.

FIG. 13 is a cross-sectional view of the FIG. 10 coupled inductor taken along line 13A-13A of FIG. 11.

FIG. 14 is a cross-sectional view of the FIG. 10 coupled inductor taken along line 14A-14A of FIG. 10.

FIG. 15 is a cross-sectional view of the FIG. 10 coupled inductor taken along line 15A-15A of FIG. 10.

FIG. 16 is another cross-sectional view of the FIG. 5 coupled inductor taken along line 6A-6A of FIG. 5 that is marked-up to show magnetic core portions between immediately adjacent windings.

FIG. 17A includes six graphs illustrating an example of voltage waveforms in an embodiment of the FIG. 3 multi-phase switching power converter.

FIG. 17B includes six graphs illustrating voltage waveforms under a different firing order than that of the FIG. 17A example.

FIG. 18A includes six graphs illustrating another example of voltage waveforms in an embodiment of the FIG. 3 multi-phase switching power converter.

FIG. 18B includes six graphs illustrating voltage waveforms under a different firing order than that of the FIG. 18A example.

FIG. 19 is a flow chart of a method for reducing magnetic core losses in a multi-phase switching power converter including a coupled inductor, according to an embodiment.

FIG. 20 is a cross-sectional view of the FIG. 5 coupled inductor that is marked-up to illustrate operation of the FIG. 3 multi-phase switching power converter according to the FIG. 19 method.

FIG. 21 is a flow chart of another method for reducing magnetic core losses in a multi-phase switching power converter including a coupled inductor, according to an embodiment.

FIG. 22 is a cross-sectional view of the FIG. 5 coupled inductor that is marked-up to illustrate operation of the FIG. 3 multi-phase switching power converter according to the FIG. 21 method.

FIG. 23 is a flow chart of another method for reducing magnetic core losses in a multi-phase switching power converter including a coupled inductor, according to an embodiment.

FIG. 24 is a cross-sectional view of the FIG. 5 coupled inductor that is marked-up to illustrate operation of the FIG. 3 multi-phase switching power converter according to the FIG. 23 method.

FIG. 25 is a flow chart of another method for reducing magnetic core losses in a multi-phase switching power converter including a coupled inductor, according to an embodiment.

FIG. 26 is a cross-sectional view of the FIG. 10 coupled inductor that is marked-up to illustrate operation of the FIG. 9 multi-phase switching power converter according to the FIG. 25 method.

FIG. 27 is a flow chart of another method for reducing magnetic core losses in a multi-phase switching power converter including a coupled inductor, according to an embodiment.

FIG. 28 is a flow chart of an additional method for reducing magnetic core losses in a multi-phase switching power converter including a coupled inductor, according to an embodiment.

FIG. 29 is a block diagram of one possible embodiment of a controller that is capable of being configured to achieve a desired order of firing phases.

FIG. 30 is a block diagram illustrating one example of how a desired order of firing phases may be achieved when using a controller with a fixed firing order, according to an embodiment.

FIG. 31 is a schematic diagram of an alternate embodiment of the FIG. 3 multi-phase switching power converter configured to have a boost topology.

FIG. 32 is a schematic diagram of an alternate embodiment of the FIG. 3 multi-phase switching power converter configured to have a buck-boost topology.

FIG. 33 is a schematic diagram of an alternate embodiment of the FIG. 3 multi-phase switching power converter configured to receive power from a plurality of input power nodes and to provide power to a plurality of output power nodes.

FIG. 34 illustrates another possible implementation of switching stages of the FIG. 3 multi-phase switching power converter.

### DETAILED DESCRIPTION OF THE EMBODIMENTS

An inductor includes one or more windings and a magnetic core. The magnetic core is formed of a magnetic material, such as a ferrite magnetic material, a composite magnetic material, and/or a powder iron magnetic material. Current flowing through a winding generates magnetic flux, and the magnetic core provides a low reluctance path for the magnetic flux. Changing magnitude of the magnetic flux flowing through the magnetic core, such as caused by changing magnitude of current flowing through the winding, causes losses in the magnetic core, typically referred to as core losses.

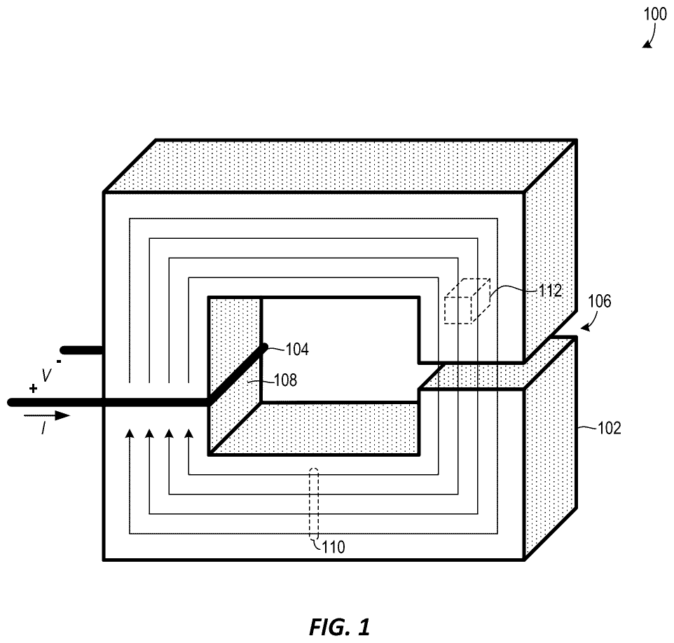

For example, FIG. 1 is an illustration of a discrete inductor 100 including a magnetic core 102 and a winding 104. Magnetic core 102 forms a gap 106, and winding 104 is wound around a portion of magnetic core 102 referred to as a winding post 108. FIG. 1 illustrates a voltage V applied across winding 104, which causes a current I to flow through winding 104. Current I flowing through winding 104 generates a magnetic flux 110 flowing through magnetic core 102, where magnetic flux 110 is symbolically shown by a plurality of line segments in FIG. 1.

Cores losses in a unit volume 112 of magnetic core 102 can be approximated using EQN. 1 below, assuming that magnetic flux density is substantially uniform in unit volume 112, where (a) P_{v_112} are core losses in unit volume 112, (b) B is a changing magnitude of density of magnetic flux 110 in unit volume 112, (c) f is frequency of a changing current I in the winding 104 associated with changing magnitude of the magnetic flux 110 density, (d) and k, α, and β are Steinmetz coefficients which are a function of, for example, composition of magnetic core 102, temperature of magnetic core 102, magnitude of current I in winding 104, and shape of current I in winding 104. Importantly, coefficient β typically ranges from approximately 2.4 to 3.4, and core losses in magnetic core 102 are therefore highly nonlinear. As such, core losses increase exponentially with increasing changing magnitude of magnetic flux 110 density, and a small increase in changing magnetic flux 110 density may therefore cause a large increase in core losses. Therefore, it is desirable that changing magnitude of magnetic flux 110 density be small to promote low core losses in magnetic core 102.

$${P}_{v \_ 112} = k \cdot β \cdot {f}^{α} \cdot {B}^{β} \qquad ( EQN . 1 )$$

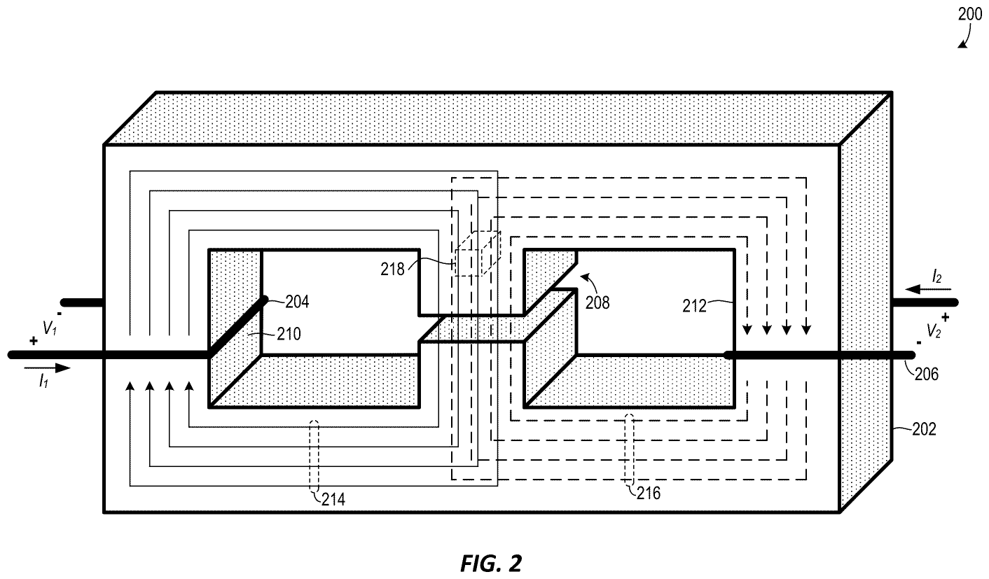

Core losses may be particularly acute in a coupled inductor due to the possibility of high magnetic flux density resulting from current simultaneously flowing through two or more windings. For example, FIG. 2 is an illustration of a coupled inductor 200 including a magnetic core 202, a first winding 204, and a second winding 206. Magnetic core 202 forms a gap 208, first winding 204 is wound around a first winding post 210 of magnetic core 202, and second winding 206 is wound around a second winding post 212 of magnetic core 202. FIG. 2 illustrates a changing voltage V₁ applied across first winding 204, which causes a changing current I₁ to flow through first winding 204. Additionally, FIG. 2 illustrates a changing voltage V₂ applied across second winding 206, which causes a changing current I₂ to flow through second winding 206. Current I₁ flowing through first winding 204 generates a first magnetic flux 214 flowing through magnetic core 202, where first magnetic flux 214 is symbolically shown by a plurality of solid line segments in FIG. 2. Additionally, current I₂ flowing through second winding 206 generates a second magnetic flux 216 flowing through magnetic core 202, where second magnetic flux 216 is symbolically shown by a plurality of dashed line segments in FIG. 2. These fluxes are associated with leakage magnetic fluxes in the first and second windings that both go into a unit volume 218 of the common leakage leg of the core, and mutual magnetic fluxes of associated with first winding 204 and second winding 206 are not shown in FIG. 2 for illustrative clarity.

Both first magnetic flux 214 and second magnetic flux 216 will flow through certain portions of magnetic core 202, such as a unit volume 218 of magnetic core 202. Assuming that changing currents I₁ and I₂ have a common frequency and phase, and magnetic flux intensity in unit volume 218 of magnetic core 202 is approximately uniform, core losses in unit volume 218 can be approximated using EQN. 2 below, where (a) P_{v_218} are core losses in unit volume 218, (b) k, α, and β are the same as discussed above with respect to EQN. 1, (c) B₁ is changing magnitude of density of first magnetic flux 214 in unit volume 218, (d) B₂ is changing magnitude of density of second magnetic flux 216 in unit volume 218, and (e) f is frequency of each of changing currents I₁ and I₂. As discussed above, coefficient β typically ranges from approximately 2.4 to 3.4, and core losses in unit volume 218 of magnetic core 202 are therefore greater than the sum of respective core losses from each changing current I₁ and current I₂. Consequently, driving first winding 204 and second winding 206 in manner which causes high dynamic flux density in magnetic core 202 may result in very high core losses. This simplified example assumes that the flux densities change in the same direction with the same timing and that the changing flux densities are completely additive. It is possible, though, to change the phasing between the changing flux densities so that they are at least partially subtractive.

$${P}_{v \_ 218} = k \cdot β \cdot {f}^{α} \cdot {( {B}_{1} + {B}_{2} )}^{β} \qquad ( EQN . 2 )$$

Disclosed herein are multi-phase switching power converters with low core losses, and associated methods, which help minimize core losses caused by high changing magnetic flux density in a magnetic core, such as by distributing flow of changing magnetic flux in the magnetic core to help minimize peak changing magnetic flux density in the magnetic core. For example, certain embodiments of the new multi-phase switching power converters and associated methods control phases of a multi-phase switching power converter to generate periodic voltage waveforms that are applied across windings of a coupled inductor with phase shift among the voltage waveforms such that at least two consecutive peak magnitude portions of the plurality of periodic voltage waveforms are not applied to respective windings that are immediately physically adjacent to each other. For instance, in some embodiments, at least some phases having respective windings that are immediately physically adjacent to each other in the coupled inductor are not consecutively fired, to help separate, within a magnetic core, respective changing magnetic flux of consecutively fired phases. Such manner of controlling the phases helps physically separate voltage waveforms having high harmonic content, as well current waveforms having high slew rate, in the coupled inductor, which helps minimize high magnetic flux density with a high changing rate in a magnetic core of the coupled inductor, thereby helping avoid large core losses resulting from the typically highly non-linear relationship between changing magnetic flux density and magnetic core losses. Accordingly, the new multi-phase switching power converters and associated methods promote efficient multi-phase switching power converter operation. Additionally, the new multi-phase switching power converters and associated methods may reduce potential for magnetic core saturation by helping prevent high magnetic flux density in a magnetic core of a coupled inductor. Furthermore, the reduced potential for saturation potentially achieved by the new multi-phase switching power converters and associated methods may enable decrease in switching frequency, as larger peak currents and larger imbalance among phases may be acceptable in view of the reduced potential for magnetic saturation.

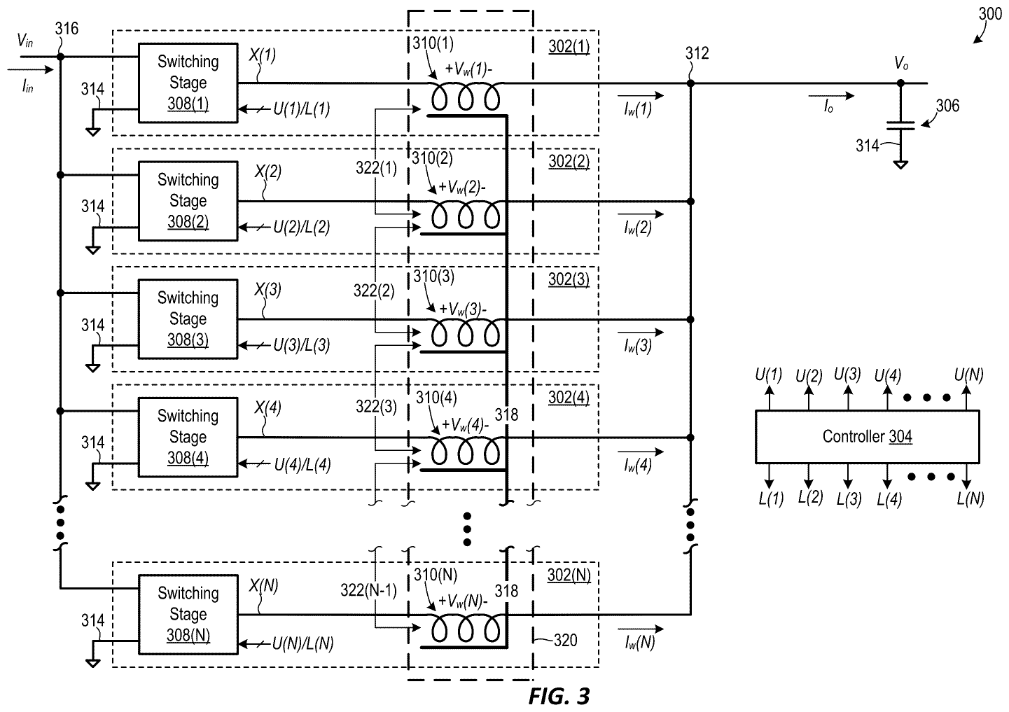

FIG. 3 is a schematic diagram of a multi-phase switching power converter 300, which is one embodiment of the new multi-phase switching power converters disclosed herein. Multi-phase switching power converter 300 includes N phases 302, a controller 304, and one or more optional output capacitors 306, where N is an integer greater than or equal to four. In this document, specific instances of an item may be referred to by use of a numeral in parentheses (e.g., phase 302(1)) while numerals without parentheses refer to any such item (e.g., phases 302). Each phase 302 includes a switching stage 308 electrically coupled to a winding 310 at a switching node X. While FIG. 3 indicates that N is greater than four, it is understood that N could be equal to four.

Each winding 310 is electrically coupled between the switching node X of its respective phase 302 and a common output power node 312. For example, winding 310(1) is electrically coupled between switching node X(1) and output power node 312, and winding 310(2) is electrically coupled between switching node X(2) and output power node 312. Output power node 312 has a voltage Vₒ relative to a reference node 314, and an output current Iₒ flows to a load (not shown) electrically coupled to output power node 312. Output current Iₒ could have a negative polarity without departing from the scope hereof. One or more output capacitors 306 are optionally electrically coupled between output power node 312 and reference node 314. Reference node 314 is depicted as being a ground node, such as an earth ground node or a chassis ground node. It is understood, though, that reference node 314 needs not be a ground node, and reference node 314 accordingly could be at a different electrical potential than an earth ground or a chassis ground.

Each switching stage 308 is configured to repeatedly switch the switching node X of its phase 302 between an input power node 316 and reference node 314, in response to control signals U and L generated by controller 304, thereby generating a voltage waveform V_{w}, e.g., a square wave voltage waveform, across its respective winding 310. Connections between controller 304 and switching stages 308 are not shown for illustrative clarity, although it is understood that one or more communication buses may communicatively couple control signals U and L from controller 304 to switching stages 308. Switching stage 308(1) is configured to repeatedly switch node X(1) between input power node 316 and reference node 314 in response to control signals U(1) and L(1) to generate a voltage waveform V_{w}(1) across winding 310(1), switching stage 308(2) is configured to repeatedly switch node X(2) between input power node 316 and reference node 314 in response to control signals U(2) and L(2) to generate a voltage waveform V_{w}(2) across winding 310(2), and so on. Input power node 316 is at a voltage Vᵢₙ relative to reference node 314, and each switching stage 308 accordingly repeatedly switches node X of its phase 302 between voltage Vᵢₙ and zero volts relative to reference node 314. An input current Iᵢₙ flows from an electrical power source (not shown) to multi-phase switching power converter 300 via input power node 316. Input current Iᵢₙ could have a negative polarity without departing from the scope hereof. One or more input capacitors (not shown) are optionally electrically coupled between input power node 316 and reference node 314.

In this document, a phase of a multi-phase switching power converter is “fired” by initiating a switching cycle of the phase, such as by connecting a switching node of the phase to a node, e.g., to a power node or to a reference node. For example, in the case of multi-phase switching power converter 300, a phase 302 is “fired” by its respective switching stage 308 connecting its respective switching node X to input power node 316. For example, phase 302(1) is fired by switching stage 308(1) connecting switching node X(1) to input power node 316, e.g., by switching stage 308(1) changing its operating state such that switching node X(1) is connected to input power node 316 instead of being connected to reference node 314. As another example, phase 302(2) is fired by switching stage 308(2) connecting switching node X(2) to input power node 316, e.g., by switching stage 308(2) changing its operating state such that switching node X(2) is connected to input power node 316 instead of being connected to reference node 314. As discussed below, certain embodiments of multi-phase switching power converter 300 are configured so that controller 304 controls phases 302 so that phases 302 are fired out of phase, i.e., so that each phase 302 is fired at a different time.

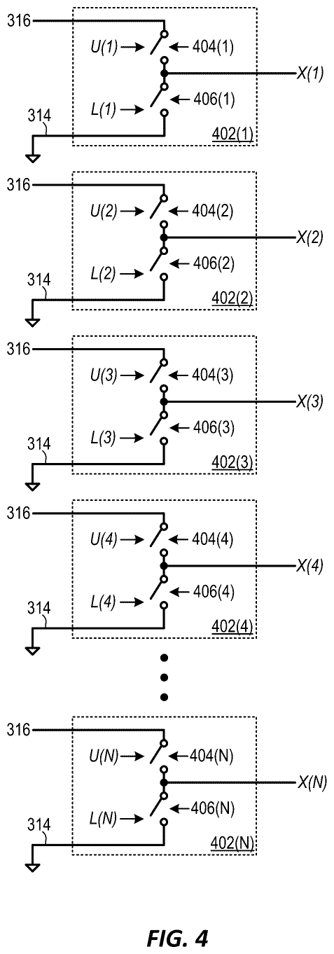

FIG. 4 illustrates one possible implementation of the switching stages 308 of multi-phase switching power converter 300. Specifically, FIG. 4 is a schematic diagram of N switching stages 402, where switching stages 402 are an embodiment of switching stages 308 of FIG. 3. Each switching stage 402 includes an upper switching device 404 and a lower switching device 406. Each upper switching device 404 is electrically coupled between input power node 316 and the switching node X of its respective phase 302. Each lower switching device 406 is electrically coupled between the switching node X of its respective phase 302 and reference node 314. For example, upper switching device 406(1) is electrically coupled between input power node 316 and switching node X(1), and lower switching device 406(1) is electrically coupled between switching node X(1) and reference node 314. Each upper switching device 404 switches in response to a respective control signal U from controller 304, and each lower switching device 406 switches in response to a respective control signal L from controller 304. For example, in some embodiments, each upper switching device 404 operates in its on (conductive) state when its respective control signal U is asserted, and the switching device operates in its off (non-conductive state) when its respective control signal U is de-asserted. Similarly, in some embodiments, each lower switching device 406 operates in its on (conductive) state when its respective control signal Lis asserted, and the switching device operates in its off (non-conductive state) when its respective control signal L is de-asserted. Each switching device 404 and 406 includes, for example, one or more transistors.

Referring again to FIG. 3, windings 310 are magnetically coupled by a magnetic core 318. Additionally, magnetic core 318 provides a leakage magnetic flux path for each winding 310. Windings 310 and magnetic core 318 are part of a coupled inductor 320. Magnetic core 318 is formed, for example, of a ferrite magnetic material and/or an iron powder magnetic material. In this document, two windings of a coupled inductor are immediately physically adjacent to each other if there are no other windings of the coupled inductor located between the two windings. For example, FIG. 3 includes brackets 322 indicating windings 310 that are immediately physically adjacent to each other in coupled inductor 320, where two windings 310 are immediately physically adjacent to each other if there is no intervening winding 310 between the two windings. In particular, bracket 322(1) indicates that windings 310(1) and 310(2) are immediately physically adjacent to each other, bracket 322(2) indicates that windings 310(2) are 310(3) are immediately physically adjacent to each other, and so on. Conversely, a lack of a bracket 322 between two windings 310 in FIG. 3 indicates that the two windings are not immediately physically adjacent to each other, or stated differently, that there is one or more other intervening windings 310 located between the two windings in coupled inductor 320. For example, FIG. 3 does not include a bracket 322 connecting windings 310(1) and 310(3), and windings 310(1) and 310(3) are therefore not immediately physically adjacent to each other, or stated differently, the lack of a bracket connecting windings 310(1) and 310(3) means that there is at least one intervening winding 310 located between windings 310(1) and 310(3).

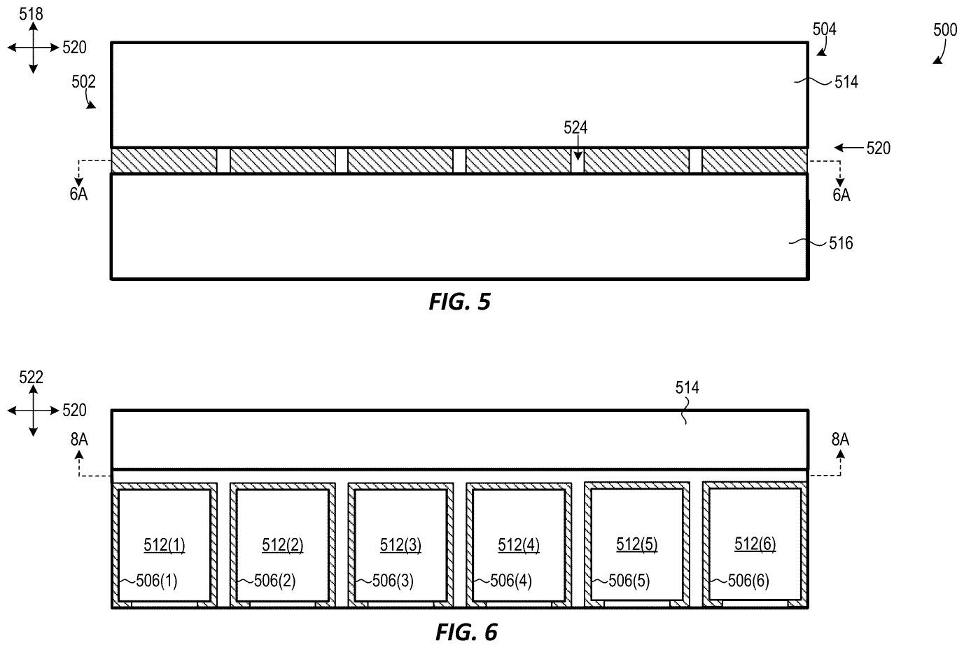

Coupled inductor 320 can have essentially any configuration as long as (a) at least two windings 310 are immediately physically adjacent to each other and (b) at least two windings 310 are not immediately physically adjacent to each other. Discussed below with respect to FIGS. 5-8 are one possible embodiment of coupled inductor 320. It is understood, though, that coupled inductor 320 can be embodied in other manners without departing from the scope hereof.

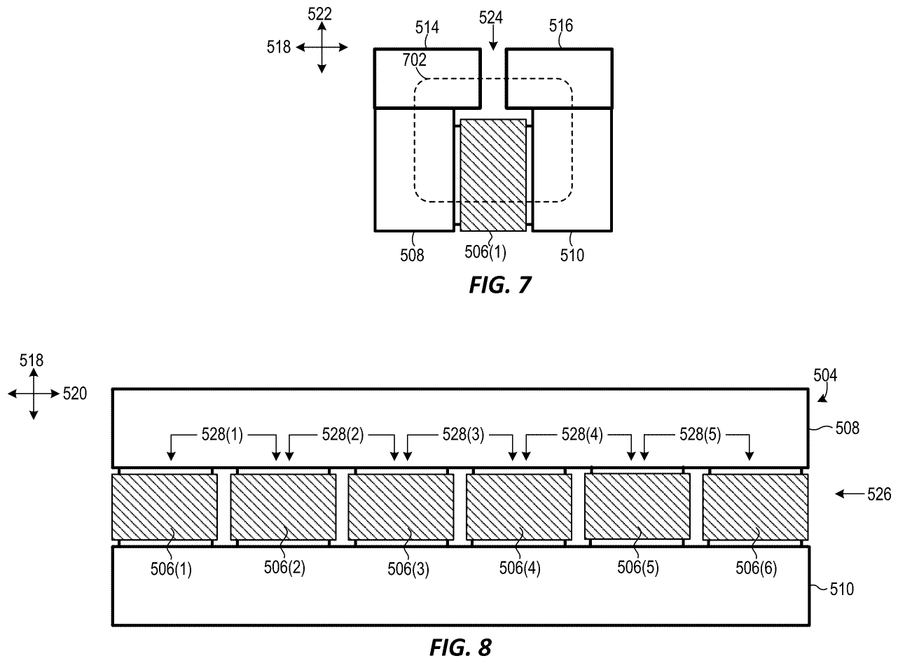

FIG. 5 is top plan view of a coupled inductor 500, which is one embodiment of coupled inductor 320 where N is equal to six. FIG. 6 is a cross-sectional view of coupled inductor 500 taken along line 6A-6A of FIG. 5, and FIG. 7 is an elevational view of a side 502 of coupled inductor 500 (see FIG. 5 for an identification of side 502). FIG. 8 is a cross-sectional view of coupled inductor 500 taken along line 8A-8A of FIG. 6. Coupled inductor 500 includes a magnetic core 504 and N windings 506. Magnetic core 504 is an embodiment of magnetic core 318, and magnetic core 504 includes a first rail 508, a second rail 510, N winding posts 512, a first leakage magnetic flux transmission element 514, and a second leakage magnetic flux transmission element 516, where each of the aforementioned elements of magnetic core 504 is formed of a magnetic material, such as a ferrite magnetic material and/or an iron powder magnetic material. First rail 508 and second rail 510 are separated from each other in a direction 518, and each of the N winding posts 512 is disposed between first rail 508 and second rail 510 in direction 518. Additionally, each of the N winding posts 512 is separated from each other of the N windings posts 512 in a direction 520, where direction 520 is orthogonal to direction 518. Accordingly, magnetic core 504 has a ladder configuration.

First leakage magnetic flux transmission element 514 is disposed on first rail 508 in a direction 522 that is orthogonal to each of directions 518 and 520, and a second leakage magnetic flux transmission element 516 is disposed on second rail 510 in direction 522. First leakage magnetic flux transmission element 514 and second leakage magnetic flux transmission element 516 extend towards each other in direction 518, although first leakage magnetic flux transmission element 514 and second leakage magnetic flux transmission element 516 are separated from each in direction 518 by a gap 524 filled with air, paper, plastic, or magnetic material having a lower magnetic permeability than magnetic material forming first leakage magnetic flux transmission element 514 and second leakage magnetic flux transmission element 516. As discussed further below, first leakage magnetic flux transmission element 514 and second leakage magnetic flux transmission element 516 collectively provide a path for leakage magnetic flux to flow within magnetic core 504. Magnetic core 504 optionally forms one or more additional gaps (not shown), such as gaps filled with air, paper, plastic, or magnetic material having a lower magnetic permeability than magnetic material forming winding posts 512, along a path of magnetic flux traveling between first rail 508 and second rail 510 via winding posts 512.

Windings 506(1)-506(6) are an embodiment of windings 310(1)-310(6) of FIG. 3, respectively. A respective winding 506 is wound around each winding post 512. In this document, a winding that is wound around a winding post need not be completely wound around the winding post. Although each winding 506 is depicted as being a single-turn winding formed of electrically conductive foil, such as copper foil, the configurations of windings 506 may vary. For example, one or more of windings 506 may form a plurality of turns, and/or one or more of these windings may be formed of single-strand wire, or multi-strand wire, instead of electrically conductive foil.

Windings 506 are disposed in a common row 526 in coupled inductor 500, where row 526 extends in direction 520. FIG. 8 includes brackets 528 indicating windings 506 that are immediately physically adjacent to each other in coupled inductor 500. In particular, bracket 528(1) indicates that windings 506(1) and 506(2) are immediately physically adjacent to each other, bracket 528(2) indicates that windings 506(2) are 506(3) are immediately physically adjacent to each other, bracket 528(3) indicates that windings 506(3) are 506(4) are immediately physically adjacent to each other, bracket 528(4) indicates that windings 506(4) and 506(5) are immediately adjacent to each other, and bracket 528(5) indicates that windings 506(5) and 506(6) are immediately physically adjacent to each other. Conversely, a lack of a bracket 528 between two windings 506 in FIG. 8 indicates that the two windings are not immediately physically adjacent to each other. For example, windings 506(1) and 506(3) are not immediately physically adjacent to each other because winding 506(2) is located between windings 506(1) and 506(3) in direction 520. As another example, windings 506(1) and 506(4) are not immediately physically adjacent to each other because two windings, i.e., windings 506(2) and 506(3), are located between windings 506(1) and 506(4) in direction 520.

Each of first leakage magnetic flux transmission element 514 and second leakage magnetic flux transmission element 516 is shared by all windings 506. In particular, first leakage magnetic flux transmission element 514 and second leakage magnetic flux transmission element 516 collectively form part of a leakage magnetic flux path for each winding 506. For example, FIG. 7 illustrates one possible leakage magnetic flux path 702 for winding 506(1). Path 702 includes winding post 512(1) (under winding 506(1) and therefore not readily visible in FIG. 7), first rail 508, first leakage magnetic flux transmission element 514, gap 524, second leakage magnetic flux transmission element 516, and second rail 510, where the direction of leakage magnetic flux travel along path 702 will depend on the direction of current flow in winding 506(1). It is understood that each other winding 506 will have a leakage magnetic flux path analogous to that of path 702, but with winding post 512(1) replaced with the respective winding post 512 for the winding 506. Leakage inductance of windings 506 may be adjusted during the design of coupled inductor 500, for example, by varying thickness of gap 524 in direction 518.

Coupled inductor 500 could be modified to include additional or fewer winding posts 512 and windings 506, such that N is a positive integer other than six. Additionally, coupled inductor 500 could be modified in other manners without departing from the scope hereof. For example, magnetic core 504 could be modified so that first leakage magnetic flux transmission element 514 and second leakage magnetic flux transmission element 516 are replaced with one or more other leakage magnetic flux transmission elements for controlling leakage inductance of windings 506. As another example, magnetic core 504 could be modified to minimize leakage inductance by omitting first leakage magnetic flux transmission element 514 and second leakage magnetic flux transmission element 516. As an additional example, coupled inductor 500 could be modified to include a boost winding that is magnetically coupled to all N windings 506.

Referring again to FIG. 3, brackets 322 assume that all windings 310 are disposed in a common row in coupled inductor 320. However, coupled inductor 320 could alternately be configured to include at least two rows of windings 310, such that windings 310 may be immediately adjacent in two dimensions. Furthermore, coupled inductor 320 could be alternately configured to include at least two rows and one or more columns of windings 310, such that windings 310 may be immediately adjacent in three dimensions.

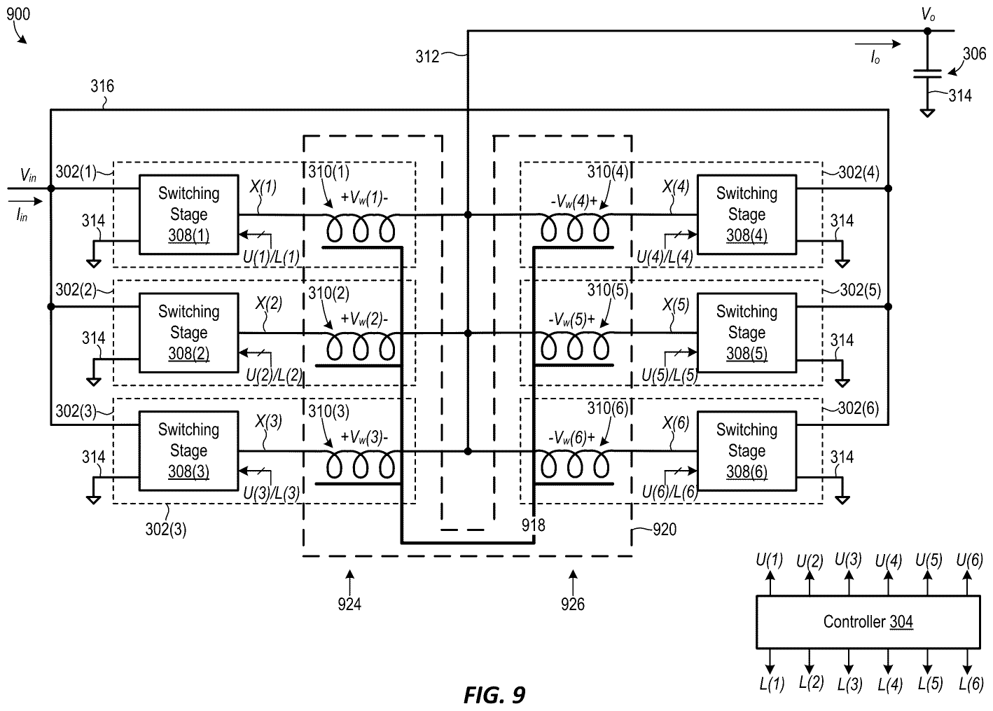

For example, FIG. 9 is a schematic diagram of a multi-phase switching power converter 900, which is an alternate embodiment of multi-phase switching power converter 300 (FIG. 3) where coupled inductor 320 is replaced with a coupled inductor 920. N is equal to six in the illustrated embodiment of multi-phase switching power converter 900, although it is understood that N could have a different value without departing from the scope hereof. Coupled inductor 920 differs from coupled inductor 320 in that magnetic core 318 is replaced with a magnetic core 918. In contrast to magnetic core 318, magnetic core 918 includes two rows of winding posts (not shown) such that windings 310 are disposed in two rows, i.e., a row 924 and a row 926.

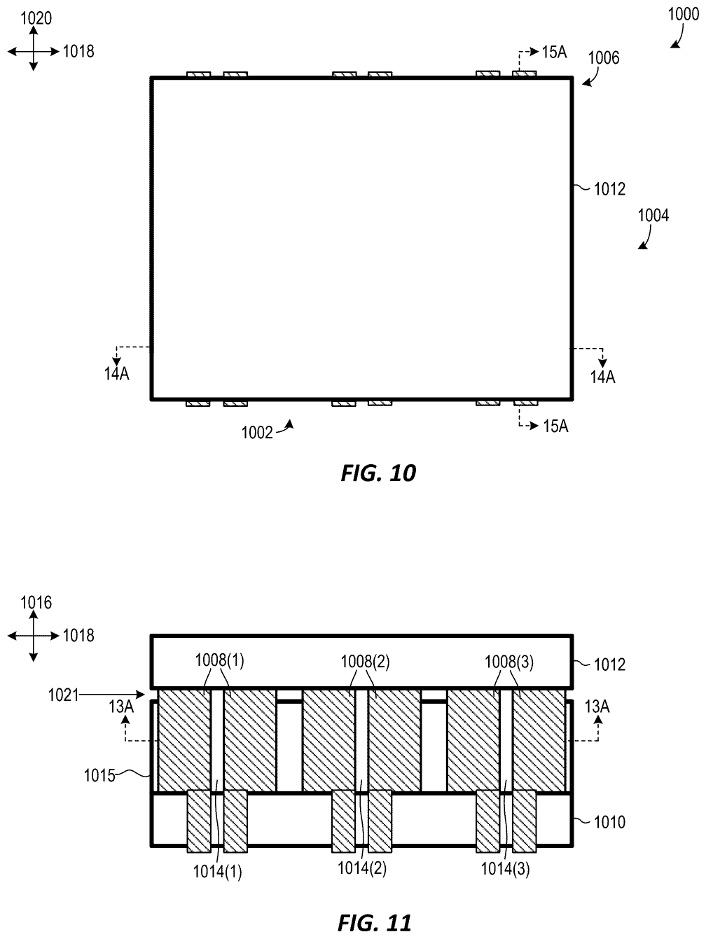

Discussed below with respect to FIGS. 10-15 are one possible embodiment of coupled inductor 920. It is understood, though, that coupled inductor 920 can be embodied in other manners without departing from the scope hereof.

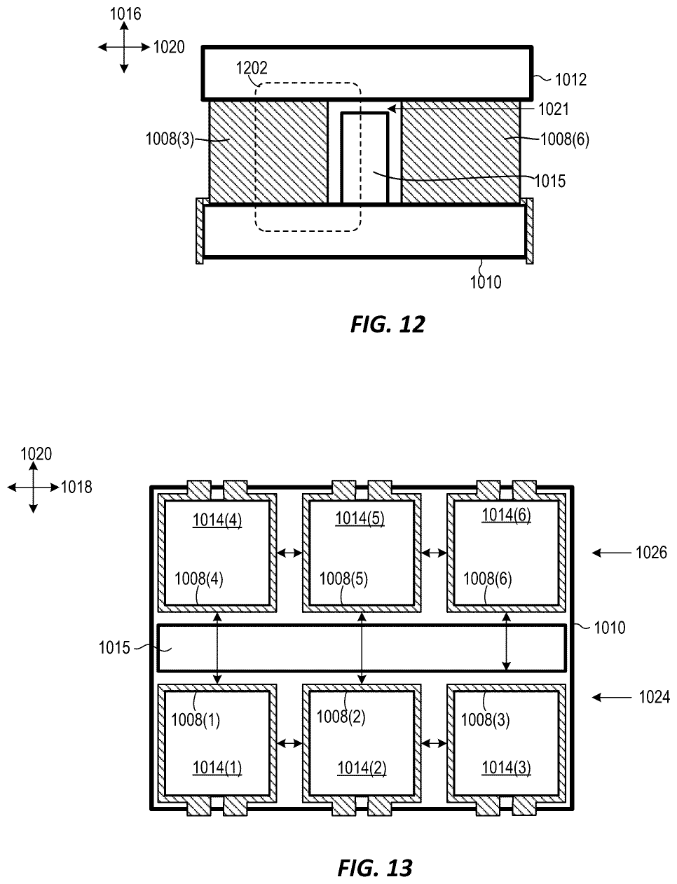

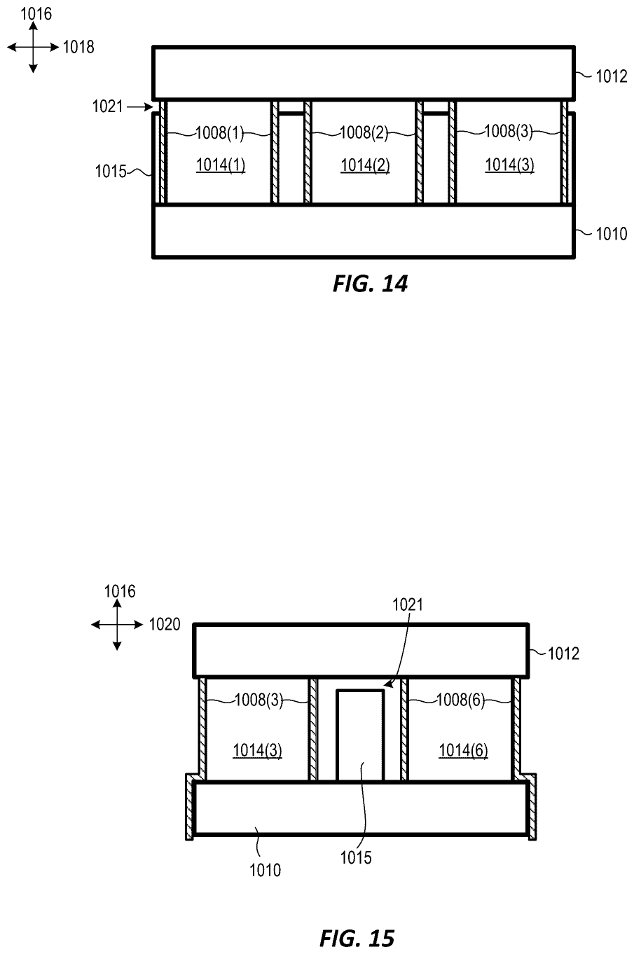

FIG. 10 is top plan view of a coupled inductor 1000, which is one embodiment of coupled inductor 920. FIG. 11 is an elevational view of a front 1002 of coupled inductor 1000, and FIG. 12 is an elevational view of a side 1004 of coupled inductor 1000 (see FIG. 10 for an identification of front 1002 and side 1004). FIG. 13 is a cross-sectional view of coupled inductor 1000 taken along line 13A-13A of FIG. 11, FIG. 14 is a cross-sectional view of coupled inductor 1000 taken long line 14A-14A of FIG. 10, and FIG. 15 is a cross-sectional view of coupled inductor 1000 taken long line 15A-15A of FIG. 10. Coupled inductor 1000 includes a magnetic core 1006 and N windings 1008. Magnetic core 1006 is an embodiment of magnetic core 918, and magnetic core 1006 includes a first rail 1010, a second rail 1012, N winding posts 1014, and a leakage magnetic flux transmission element 1015, where each of the aforementioned elements of magnetic core 1006 is formed of a magnetic material, such as a ferrite magnetic material and/or an iron powder magnetic material. First rail 1010 and second rail 1012 are separated from each other in a direction 1016, and each of the N winding posts 1014 is disposed between first rail 1010 and second rail 1012 in direction 1016. Additionally, each of the N winding posts 1014 is separated from each other of the N windings posts 1014 in a direction 1018 and in a direction 1020, where direction 1018 is orthogonal to direction 1016 and direction 1020 is orthogonal to each of directions 1016 and 1018. Magnetic core 1006 optionally forms one or more gaps (not shown), such as gaps filled with air, paper, plastic, or magnetic material having a lower magnetic permeability than magnetic material forming first rail 1010, second rail 1012, and N winding posts 1014, along winding posts 1014.

Leakage magnetic flux transmission element 1015 is disposed on first rail 1010 in direction 1016 and extends toward second rail 1012 in direction 1016. Leakage magnetic flux transmission element 1015 is separated from second rail 1012 in direction 1016 by a gap 1021. Gap 1021 is filed with, for example, air, plastic, paper, or magnetic material having a lower magnetic permeability than magnetic material forming leakage magnetic flux transmission element 1015. As discussed further below, leakage magnetic flux transmission element 1015 provides a path for leakage magnetic flux to flow within magnetic core 1006.

Windings 1008(1)-1008(6) are an embodiment of windings 310(1)-310(6), respectively, of FIG. 9. A respective winding 1008 is wound around each winding post 1014. Although each winding 1008 is depicted as being a single-turn winding formed of electrically conductive foil, such as copper foil, the configurations of windings 1008 may vary. For example, one or more of windings 1008 may form a plurality of turns, and/or one or more of these windings may be formed of single-strand wire, or multi-strand wire, instead of electrically conductive foil.

As illustrated in FIG. 13, windings 1008 are disposed in two rows, i.e., rows 1024 and 1026, which are embodiments of rows 924 and 926, respectively, of FIG. 9. Accordingly, windings 1008 may be immediately adjacent to each other in two dimensions, i.e., in direction 1018 as well as in direction 1020. FIG. 13 includes arrows indicating immediately physically adjacent windings 1008. For example, winding 1008(1) is immediately physically adjacent to each of windings 1008(2) and 1008(4), as indicted by respective arrows between winding 1008(1) and each of windings 1008(2) and 1008(4). As another example, winding 1008(2) is immediately physically adjacent to each of windings 1008(1), 1008(3), and 1008(5), as indicated by respective arrows between winding 1008(2) and each of windings 1008(1), 1008(3), and 1008(5).

Leakage magnetic flux transmission element 1015 is shared by all windings 1008. In particular, leakage magnetic flux transmission element 1015 forms part of a leakage magnetic flux path for each winding 1008. For example, FIG. 12 illustrates one possible leakage magnetic flux path 1202 for winding 1008(3). Path 1202 includes winding post 1014(3) (under winding 1008(3) and therefore not visible in FIG. 12), first rail 1010, leakage magnetic flux transmission element 1015, gap 1021, and second rail 1012, where the direction of leakage magnetic flux travel along path 1202 will depend on the direction of current flow in winding 1008(3). It is understood that each other winding 1008 will have a leakage magnetic flux path analogous to that of path 1202, but with winding post 1014(3) replaced with the respective winding post 1014 for the winding 1008. Leakage inductance of windings 1008 may be adjusted during the design of coupled inductor 1000, for example, by varying thickness of gap 1021 in direction 1016. The configuration of leakage magnetic flux transmission element 1015 may be varied without departing from the scope hereof. For example, the location of leakage magnetic flux transmission element 1015 in magnetic core 1006 may vary, leakage magnetic flux transmission element 1015 may be replaced with two or more leakage magnetic flux transmission elements in magnetic core 1006, etc. Additionally, leakage magnetic flux transmission element 1015 may be omitted from magnetic core 1006 without departing the scope hereof.

Referring again to FIG. 3, controller 304 is implemented, for example, by analog and/or electronic circuitry. In some embodiments, controller 304 is at least partially implemented by a processor (not shown) executing instructions in the form of software and/or firmware stored in a memory (not shown). Although controller 304 is depicted as a discrete element for illustrative simplicity, controller 304 could be partially or fully integrated with one or more other elements of multi-phase switching power converter 300. For example, some subsystems of controller 304 could be incorporated in switching stages 308. Additionally, FIG. 3 should not be construed to require that there be a separate communication bus for each control signal. For example, controller 304 could be implemented by a combination of a central integrated circuit and local control logic integrated in each switching stage 308, with a single communication bus running from the central integrated circuit to each switching stage 308. Furthermore, controller 304 may include multiple constituent elements that need not be co-packaged or even disposed at a common location.

Controller 304 is configured to generate control signals U and L to control duty cycle (D) of phase 302, where duty cycle is a portion of a switching cycle of each phase 302 of multi-phase switching power converter 300 that the winding 310 of the phase 302 is driven high, i.e., when the switching node X of the phase 302 is connected to input power node 316, to regulate at least one parameter of switching power converter 300. In some embodiments, controller 304 is configured to control duty cycle of phases 302 using pulse width modulation (PWM) and/or pulse frequency modulation (PFM). Examples of possible regulated parameters include, but are not limited, magnitude of input voltage Vᵢₙ, magnitude of input current Iᵢₙ, magnitude of output voltage Vₒ, and magnitude of output current Iₒ. For example, in some embodiments, controller 304 is configured to generate control signals U and L to regulate magnitude of output voltage Vₒ, and controller 304 accordingly generates control signals U and L during continuous conduction operation of multi-phase switching power converter 300 such that duty cycle of phases 302 is equal to a ratio of output voltage magnitude Vₒ over input voltage magnitude Vᵢₙ. For example, if output voltage Vₒ is to be regulated to two volts and input voltage Vᵢₙ is eight volts, controller 304 would generate control signals U and L such that duty cycle of phases 302 is 0.25. Controller 304 is optionally configured to generate control signals U and Z such that phases 302 switch out-of-phase with each other. For example, in some embodiments, controller 304 is configured to generate control signals U and L such that each phase 302 switches 360/N degrees out of phase with an adjacent phase 302 in the phase domain.

Importantly, multi-phase switching power converters 300 and 900 are configured to control phases 302 to generate periodic voltage waveforms V_{w} with a phase shift among the voltage waveforms V_{w} such that at least two consecutive peak magnitude portions of voltage waveforms V_{w} are not applied to respective windings 310 that are immediately physically adjacent to each other in coupled inductor 320 or 920. Multi-phase switching power converters 300 and 900 generate periodic voltage waveforms V_{w} in such manner, for example, by controlling phases 302 such that at least some phases having respective windings 310 immediately physically adjacent to each other in coupled inductor 320 or 920 are not consecutively fired. It should be noted, though, that while phase 302 firing time may be a convenient reference point for determining phase shift among the periodic voltage waveforms V_{w}, any other time in the periodic voltage waveforms V_{w} may be used as a reference point for determining phase shift among the periodic voltage waveforms, as long as the same time is used in each periodic voltage waveform V_{w}.

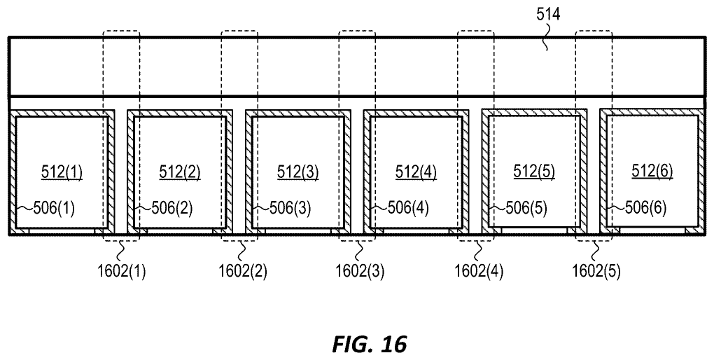

Such control of phases 302 advantageously helps minimize the changing magnetic flux density in magnetic core 318 or 918 by promoting physical separation of windings 310 that are simultaneously conducting current having a high slew rate, thereby distributing changing magnetic flux within magnetic core 318 or 918, which helps minimize summation of respective changing magnetic flux generated by two or more windings 310 in magnetic core 318 or 918. For example, consider FIG. 16, which is another cross-sectional view of coupled inductor 500 taken along line 6A-6A of FIG. 5. FIG. 16 is marked-up to show regions 1602 of magnetic core 504 that are between immediately adjacent windings 506. Controlling phases 302 such that at least two consecutive peak magnitude portions of voltage waveforms V_{w} are not applied to respective windings 506 that are immediate physically adjacent distributes flow of changing magnetic flux in magnetic core 504, which helps reduce summation of changing magnetic flux density, for example in regions 1602 of magnetic core. As an example, controlling phases 302 such that immediately physically adjacent windings 506(1) and 506(2) are not consecutively fired helps prevent summation of respective changing leakage magnetic flux of windings 506(1) and 506(2) in region 1602(1) of magnetic core 504. As another example, controlling phases 302 such that immediately physically adjacent windings 506(2) and 506(3) are not consecutively fired helps prevent summation of respective changing leakage magnetic flux of windings 506(2) and 506(3) in region 1602(2) of magnetic core 504. Accordingly, the new multi-phase switching power converters disclosed herein promote low core losses as well low susceptibility to magnetic core saturation by helping separate flow of changing magnetic flux associated with peak magnitude portions of voltage waveforms V_{w}. It should be noted that regions 1602 also include parts of opposing second rail 510 and opposing second leakage magnetic flux transmission element 516, which are not visible in the FIG. 16 cross-sectional view.

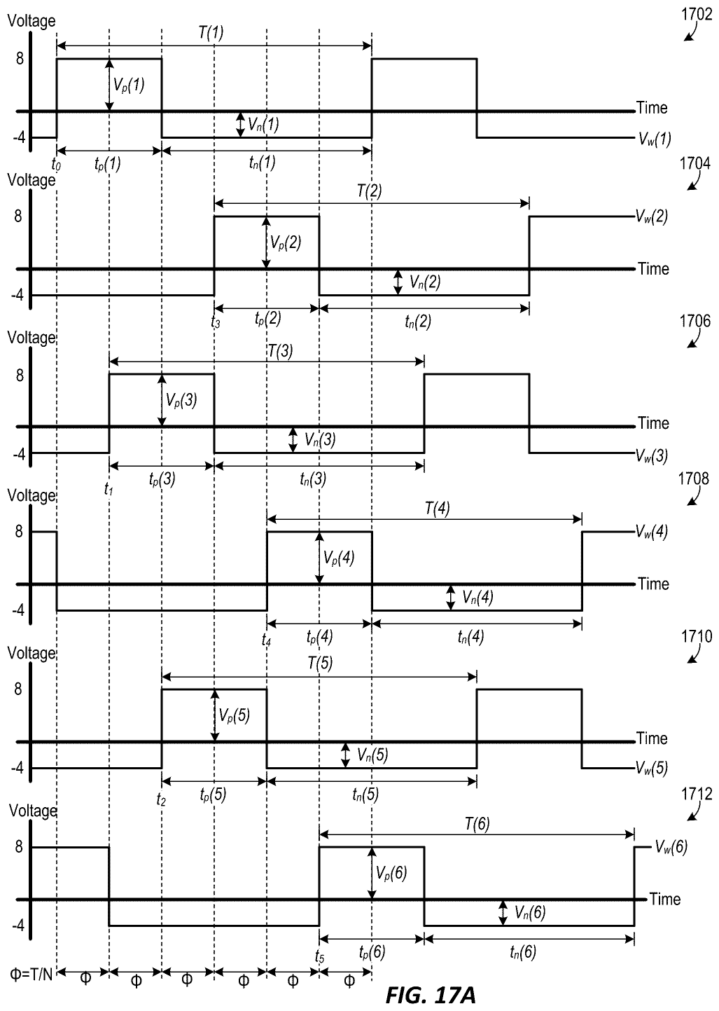

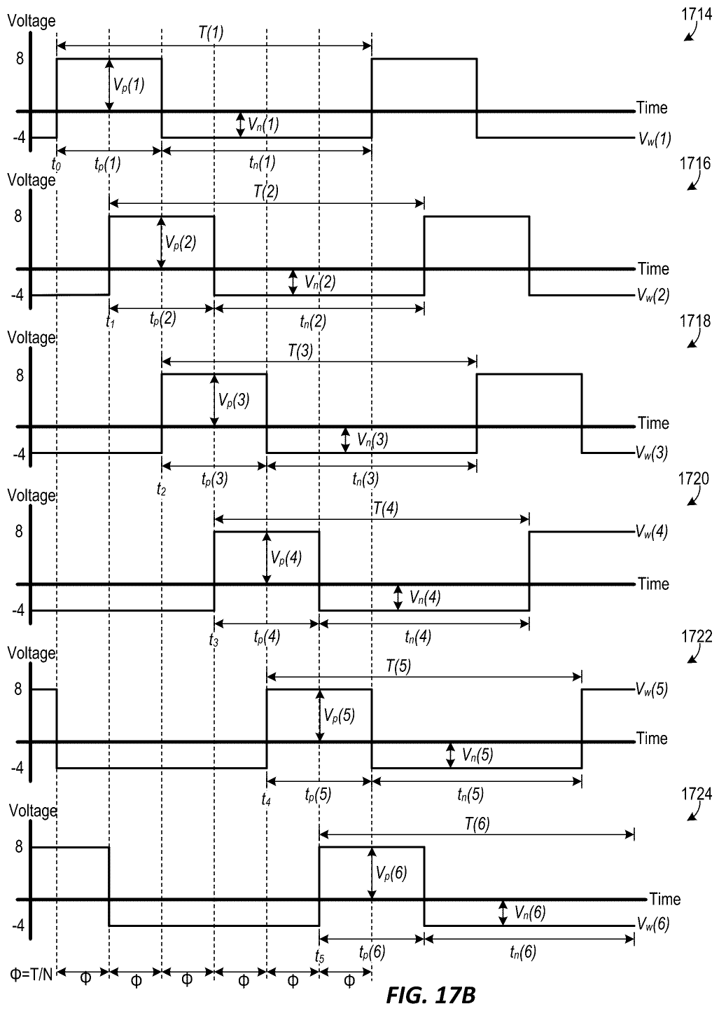

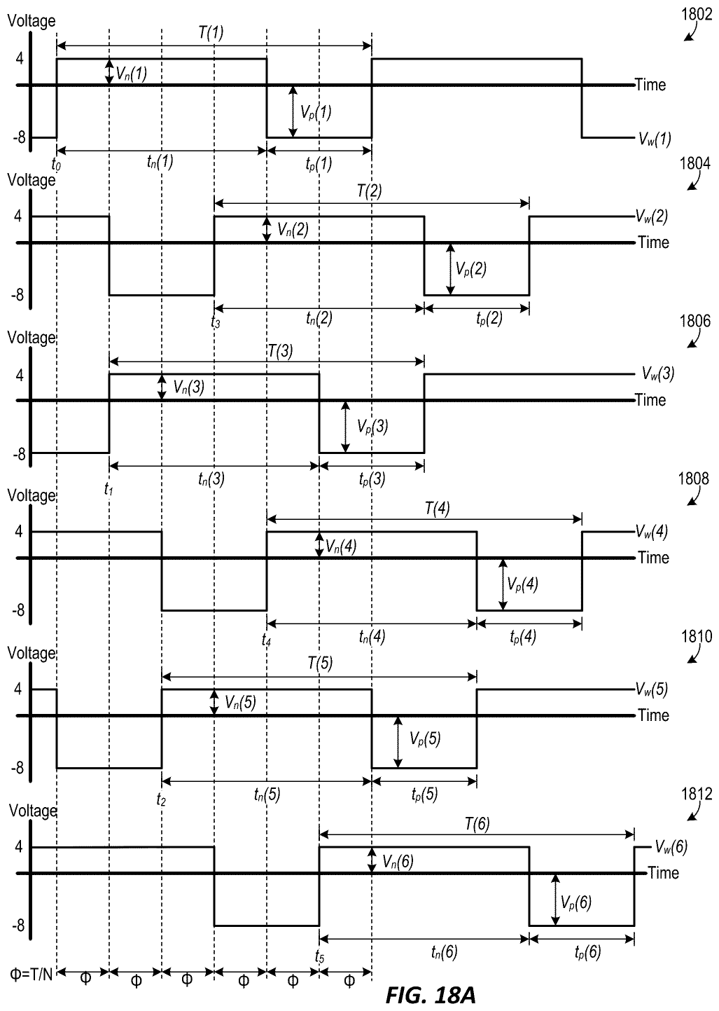

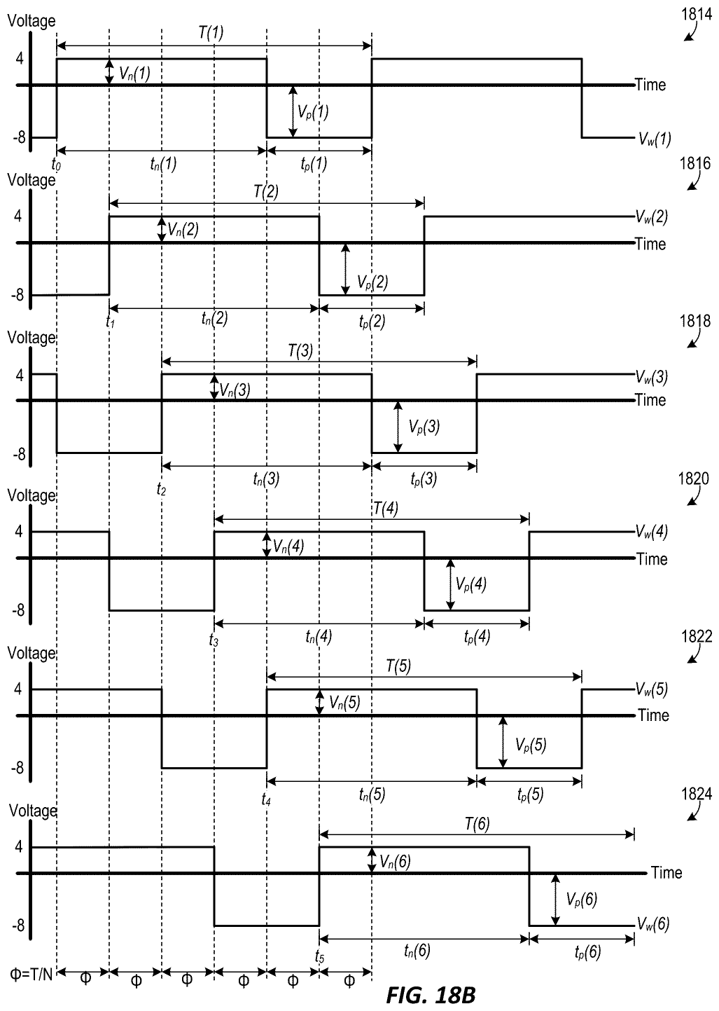

FIGS. 17A and 18A, discussed below, illustrate two examples of switching waveforms in an embodiment of multi-phase switching power converter 300 that is configured to control phases 302 such that at least two consecutive peak magnitude portions of voltage waveforms V_{w} are not applied to respective windings 310 that are immediate physically adjacent. It is understood, though, that switching power converter 300 is not limited to operating according to the example of FIGS. 17A and 18A.

FIG. 17A includes six graphs 1702, 1704, 1706, 1708, 1710, and 1712 of voltage versus time. Graphs 1702, 1704, 1706, 1708, 1710, and 1712 respectively illustrate examples of voltages waveforms V_{w}(1), V_{w}(2), V_{w}(3), V_{w}(4), V_{w}(5), and V_{w}(6) in one embodiment of multi-phase switching power converter 300 where N=6, Vᵢₙ=12 volts, Vₒ=4 volts, and each voltage waveform V_{w} is a square wave. Graphs 1702, 1704, 1706, 1708, 1710, and 1712 share a common time base. The FIG. 17A examples assume that multi-phase switching power converter 300 is operating in a steady-state operating condition such that duty cycle of phases 302 does not vary from one switching cycle to the next. Accordingly, voltages waveforms V_{w} are periodic. Each voltage waveform V_{w} has a period T which corresponds to a switching cycle of its respective phase 302. In this example, controller 304 controls switching stages 308 such that voltage waveforms V_{w} are out-of-phase with respect to each other. In particular, firing of successive phases 302 is offset by a time duration ϕ, where ϕ is equal to T/N (and N is equal to 6 in the FIG. 17A example). Consequently, switching cycles of phases 302 begin at different respective times. For example, respective switching cycles of phases 302(1), 302(2), 303(3), 303(4), 303(5), and 303(6) illustrated in FIG. 17A begin at times t₀, t₃, t₁, t₄, t₂, and t₅, respectively.

Each voltage waveform V_{w} includes a respective peak magnitude portion tₚ and a respective non-peak magnitude portion tₙ in each period T of the voltage waveform. Each peak magnitude portion tₚ of a given voltage waveform V_{w} is a portion of the voltage waveform where magnitude of voltage across its respective winding 310 is at a maximum value during the period T of the voltage waveform. Conversely, each non-peak magnitude portion tₙ of a given voltage waveform V_{w} is a portion of the voltage waveform where magnitude of voltage across its respective winding 310 is not at a maximum value during the period T of the voltage waveform. Accordingly, in each period T of a given voltage waveform V_{w}, magnitude of the voltage waveform is greater in the peak magnitude portion tₚ of the voltage waveform than in the non-peak magnitude portion tₙ of the voltage waveform. For instance, in the FIG. 17A example, each peak magnitude portion tₚ of a given voltage waveform V_{w} has a magnitude Vₚ of eight volts, while each non-peak magnitude portion tₙ of a given voltage waveform V_{w} has a magnitude Vₙ of four volts. In some alternate embodiments of multi-phase switching power converter 300, switching stages 308 are modified such that each voltage waveform V_{w} has two or more different non-peak magnitude values in a given switching cycle T of a respective phase 302.

Controller 304 is configured to fire phases in the FIG. 17A example in the following repeating sequence: phase 302(1), phase 302(3), phase 302(5), phase 302(2), phase 302(4), and phase 302(6). Consequently, there is phase shift among voltage waveforms V_{w} such that consecutive peak magnitude portions tₚ of voltage waveforms V_{w} are not applied to windings 310 that are immediately physically adjacent to each other in coupled inductor 320. For example, peak magnitude portions tₚ(1) and tₚ(3) are consecutive, i.e., peak magnitude portion tₚ(3) is the first peak magnitude portion to occur after peak magnitude portion tₚ(1). Consecutive peak magnitude portions tₚ(1) and tₚ(3) are not applied to immediately physically adjacent windings 310 in coupled inductor 320. Instead, peak magnitude portion tₚ(1) is applied to winding 310(1) and peak magnitude portion tₚ(3) is applied to winding 310(3), where windings 310(1) and 310(3) are not immediately physically adjacent to each other, as shown in FIG. 3 by the lack of a bracket 322 between the two windings. As another example, peak magnitude portions tₚ(3) and tₚ(5) are consecutive, i.e., peak magnitude portion tₚ(5) is the first peak magnitude portion to occur after peak magnitude portion tₚ(3). Consecutive peak magnitude portions tₚ(3) and tₚ(5) are not applied to immediately physically adjacent windings 310 in coupled inductor 320. Instead, peak magnitude portion tₚ(3) is applied to winding 310(3) and peak magnitude portion tₚ(5) is applied to winding 310(5), where windings 310(3) and 310(5) are not immediately physically adjacent to each other, as shown in FIG. 3 by the lack of a bracket 322 between the two windings.

In a given period T of a phase 302, the peak magnitude portion tₚ has a higher voltage waveform V_{w} harmonic content than the non-peak magnitude portion tₙ, due to duration of the peak magnitude portion tₚ being less than duration of the non-peak magnitude portion tₙ. Additionally, in a given period T of a phase 302, the fact that a ratio of voltage magnitude over time is greater in the peak magnitude portion tₚ than in the non-peak magnitude portion tₙ causes winding current I_{w} (see FIG. 3) slew rate to be greater in the peak magnitude portion tₚ than in the non-peak magnitude portion tₙ. Both high voltage waveform V_{w} harmonic content and high winding current I_{w} slew rate are associated with high magnetic core 318 losses. Accordingly, physically separating consecutive peak magnitude portions tₚ in coupled inductor 320, such as by using the phase 302 firing order illustrated in FIG. 17A, promotes low losses in magnetic core 318.

As a comparison, consider FIG. 17B which includes graphs 1714, 1716, 1718, 1720, 1722, and 1724, which are analogous to graphs 1702, 1704, 1706, 1708, 1710, and 1712, respectively, but assuming phases 302 are fired in the following repeating sequence: phase 302(1), phase 302(2), phase 302(3), phase 302(4), phase 302(5), and phase 302(6). As evident from FIG. 17B, consecutive peak magnitude portions tₚ of voltage waveforms V_{w} are applied to windings 310 that are immediately physically adjacent to each other in coupled inductor 320. Consequently, dynamic magnetic flux density in some adjacent areas of magnetic core 318 will be greater with the FIG. 17B firing sequence than with the FIG. 17A firing sequence assuming everything else is equal, resulting in higher magnetic core 318 losses with the FIG. 17B firing sequence than with the FIG. 17A firing sequence.

Peak magnitude portions tₚ occur at the beginning of switching cycles in the FIG. 17A example. However, peak magnitude tₚ portions could alternately occur at the end of switching cycles. For example, FIG. 18A includes six graphs 1802, 1804, 1806, 1808, 1810, and 1812 analogous to graphs 1702, 1704, 1706, 1708, 1710, and 1712 of FIG. 17A, respectively, of an embodiment of multi-phase switching power converter 300 configured in the same manner as in the FIG. 17A example, but where Vₒ=8 volts instead of four volts. Each phase 302 operates at a relatively large duty cycle in the FIG. 18A example due to magnitude of Vₒ being two thirds of magnitude of voltage Vᵢₙ. As result, peak magnitude portions tₚ occur at the ends of periods T, instead of at the beginning of periods T, in contrast to the FIG. 17A example. However, the order of firing phases 302 of the FIG. 18A example (which is the same as in the FIG. 17A example) still causes consecutive peak magnitude portions tₚ of voltage waveforms V_{w} to not be applied to windings 310 that are immediately physically adjacent to each other in coupled inductor 320, thereby promoting low loss in magnetic core 318.

As a comparison, consider FIG. 18B which includes graphs 1814, 1816, 1818, 1820, 1822, and 1824, which are analogous to graphs 1802, 1804, 1806, 1808, 1810, and 1812, respectively, but assuming phases 302 are fired in the following repeating sequence: phase 302(1), phase 302(2), phase 302(3), phase 302(4), phase 302(5), and phase 302(6). As evident from FIG. 18B, consecutive peak magnitude portions tₚ of voltage waveforms V_{w} are applied to windings 310 that are immediately physically adjacent to each other in coupled inductor 320. Consequently, dynamic magnetic flux density in magnetic core 318 will be greater with the FIG. 18B firing sequence than with the FIG. 18A firing sequence assuming everything else is equal, resulting in higher magnetic core 318 losses with the FIG. 18B firing sequence than with the FIG. 18A firing sequence.

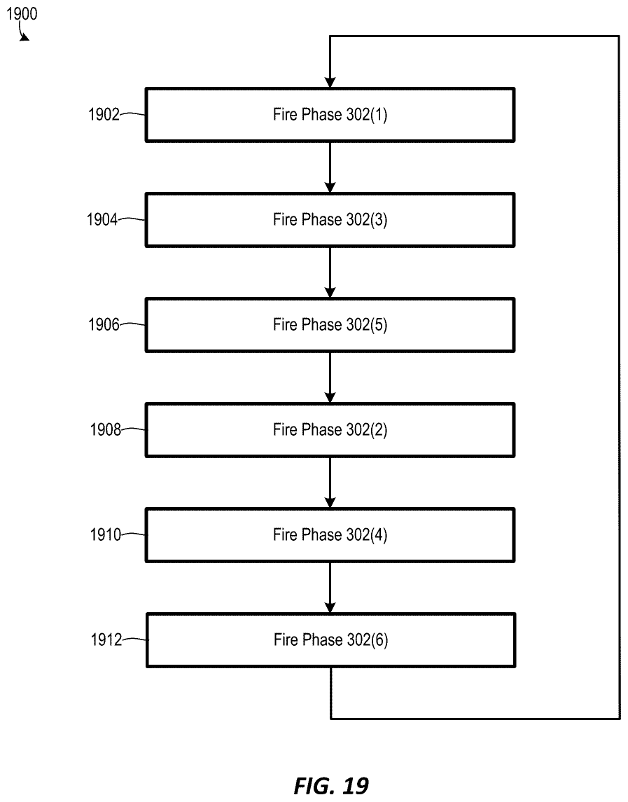

It should be realized that the new multi-phase switching power converters and associated methods are not limited to the phase firing order of FIGS. 17A and 18A, and other firing orders can accordingly be implemented so that consecutive peak magnitude portions tₚ of voltage waveforms V_{w} are not applied to windings 310 that are immediately physically adjacent to each other in coupled inductor 320. Discussed below with respect to FIGS. 19-28 are several additional examples of how the new multi-phase switching power converters disclosed herein may be configured to operate such that at least some consecutive peak magnitude portions of voltage waveforms V_{w} are not applied to windings 310 that are immediately physically adjacent to each other. It is understood, though, that the new multi-phase switching power converters disclosed herein may be configured to operate in other manners while still controlling phases 302 such that at least some consecutive peak magnitude portions of voltage waveforms V_{w} are not applied to windings 310 that are immediately physically adjacent to each other.

FIG. 19 is a flow chart of a method 1900 for reducing magnetic core losses in a multi-phase switching power converter including a coupled inductor, which is one example of how the new multi-phase switching power converters disclosed herein may control phases 302. Method 1900 assumes that (a) the multi-phase switching power converter is multi-phase switching power converter 300 of FIG. 3, (b) N is equal to six, and (c) coupled inductor 320 is embodied by coupled inductor 500 of FIG. 5. The firing order of method 1900 is like that illustrated in FIGS. 17A and 18A. In particular, in each repetition of method 1900, odd phases 302 are fired one phase at a time, and after all of the odd phases 302 are fired, even phases 302 are fired one phase at a time. Specifically, in a block 1902 of method 1900, phase 302(1) is fired, and in a block 1904 of method 1900, which is executed after block 1902, phase 302(3) is fired. In a block 1906 of method 1900, which is executed after block 1904, phase 302(5) is fired, and in a block 1908 of method 1900, which is executed after block 1906, phase 302(2) is fired. In a block 1910 of method 1900, which is executed after block 1908, phase 302(4) is fired, and in a block 1912 of method 1900, which is executed after block 1910, phase 302(6) is fired. Method 1900 returns to block 1902 after executing block 1912. Method 1900 could be modified for embodiments of multi-phase switching power converter 300 where N is greater than six. Additionally, method 1900 could be modified so that even phases 302 are fired before odd phases 302.

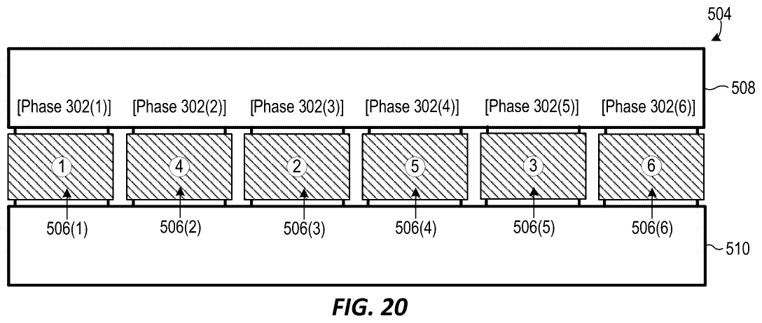

It should be appreciated that execution of method 1900 causes windings 506 that are immediately physically adjacent to each other in coupled inductor 500 to not be consecutively fired, thereby distributing flow of changing magnetic flux in magnetic core 504 which helps minimize magnitude of changing magnetic flux density in magnetic core 504. For example, FIG. 20 is a cross-sectional view of coupled inductor 500 taken along line 8A-8A of FIG. 6 that is marked-up with (a) the respective phase 302 corresponding to each winding 506 and (b) the order of firing phases 302 according to method 1900. In particular, the number 1 within a circle indicates that phase 302(1), which includes winding 506(1), is fired first, the number 2 within a circle indicates that phase 302(3), which includes winding 506(3), is fired second, and so on. As evident from FIG. 20, phases 302 with immediately physically adjacent windings 506 are not consecutively fired. For example, winding 506(2) is the closest winding 506 to winding 506(1). Phase 302(2) including winding 506(2), though, is not fired immediately after phase 302(1). Instead, phase 302(3), which includes winding 506(3), is fired immediately after phase 302(1). Winding 506(3) is further away from winding 506(1) than winding 506(2). Therefore, firing phase 302(3), instead of phase 302(2), immediately after phase 302(1) reduces potential for high changing magnetic flux density in magnetic core 504 resulting from current of large magnitude simultaneously flowing through two windings 506 that are near each other in coupled inductor 500.

It should be noted that current will continue to flow through a winding 506 for some time after the winding 506's corresponding phase 302 is fired, and in some cases, current may continuously flow through windings 506, such as if multi-phase switching power converter 300 is operating in continuous conduction mode. However, consecutively firing phases 302 with windings 506 that are relatively distant from each other causes immediately physically adjacent windings to carry respective peak currents at substantially different times, thereby helping minimize changing magnetic flux intensity and corresponding core losses in magnetic core 504.

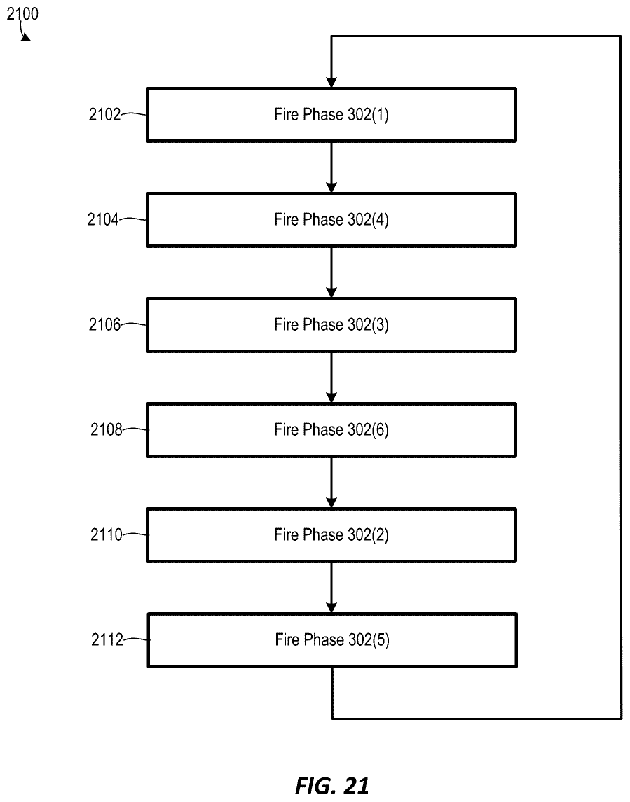

FIG. 21 is a flow chart of a method 2100 for reducing magnetic core losses in a multi-phase switching power converter including a coupled inductor, which is another example of how the new multi-phase switching power converters disclosed herein may control phases 302. Method 2100 assumes that (a) the multi-phase switching power converter is multi-phase switching power converter 300 of FIG. 3, (b) N is equal to six, and (c) coupled inductor 320 is embodied by coupled inductor 500 of FIG. 5. Method 2100 does not follow an odd and then even pattern like that of method 1900, and method 2100 generally achieves a greater separation of windings 506 of consecutively fired phases 302 than method 1900. However, method 2100 does result in one instance of phases 302 with immediately physically adjacent windings 506, i.e., phases 302(4) and 302(3), being consecutively fired.

Specifically, in a block 2102 of method 2100, phase 302(1) is fired, and in a block 2104 of method 2100, which is executed after block 2102, phase 302(4) is fired. In a block 2106 of method 2100, which is executed after block 2104, phase 302(3) is fired, and in a block 2108 of method 2100, which is executed after block 2106, phase 302(6) is fired. In a block 2110 of method 2100, which is executed after block 2108, phase 302(2) is fired, and in a block 2112 of method 2100, which is executed after block 2110, phase 302(5) is fired. Method 2100 returns to block 2102 after executing block 2112.

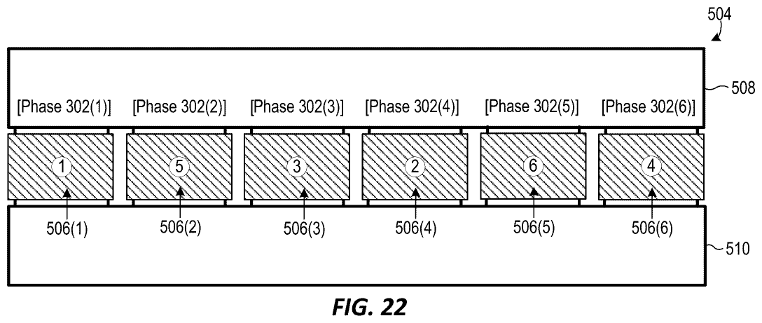

FIG. 22 is a cross-sectional view of coupled inductor 500 taken along line 8A-8A of FIG. 6 that is marked-up with (a) the respective phase 302 corresponding to each winding 506 and (b) the order of firing phases 302 according to method 2100. In particular, the number 1 in a circle indicates that phase 302(1), which includes winding 506(1), is fired first, the number 2 in a circle indicates that phase 302(4), which includes winding 506(4), is fired second, and so on. As evident from FIG. 22, phases 302 with immediately physically adjacent windings 506 are generally not consecutively fired. For example, winding 506(2) is the closest winding 506 to winding 506(1), and winding 506(3) is the second closest winding 506 to winding 506(1). Neither phase 302(2) nor phase 302(3), though, is fired immediately after phase 302(1). Instead, phase 302(4), which includes winding 506(4), is fired immediately after phase 302(1). Winding 506(4) is further away from winding 506(1) than either winding 506(2) or 506(3). Therefore, firing phase 302(4), instead of phase 302(2) or phase 302(3), immediately after phase 302(1) reduces potential for high changing magnetic flux density in magnetic core 504 resulting from current of large magnitude simultaneously flowing through two windings 506 that are near each other.

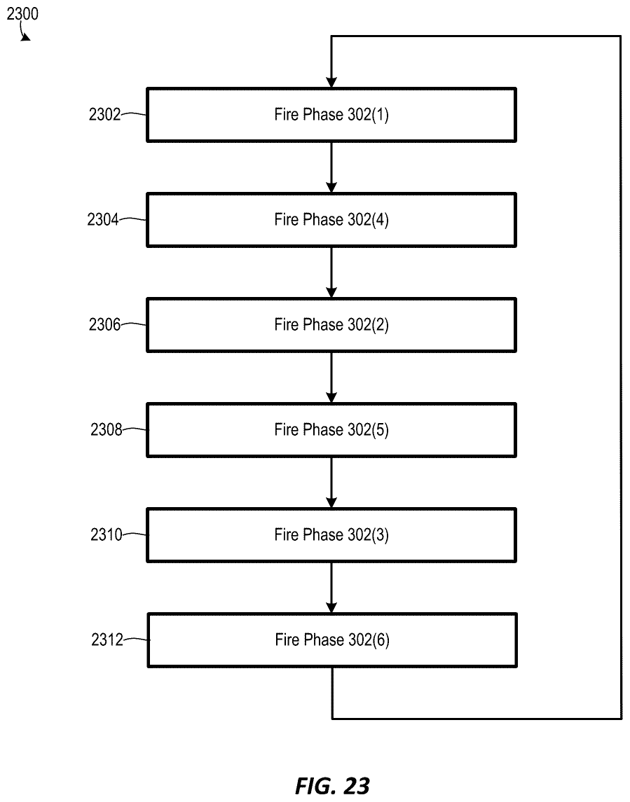

FIG. 23 is a flow chart of a method 2300 for reducing magnetic core losses in a multi-phase switching power converter including a coupled inductor, which is another example of how the new multi-phase switching power converters disclosed herein may control phases 302. Method 2300 assumes that (a) the multi-phase switching power converter is multi-phase switching power converter 300 of FIG. 3, (b) N is equal to six, and (c) coupled inductor 320 is embodied by coupled inductor 500 of FIG. 5. Method 2300 groups windings into two groups, i.e., a first group including phases 302(1), 302(2), and 302(3), and a second group including 302(4), 302(5), and 302(6). Method 2300 alternately fires one phase from each group until all phases are fired within a given repetition of method 2300. Specifically, in a block 2302 of method 2300, phase 302(1) is fired, and in a block 2304 of method 2300, which is executed after block 2302, phase 302(4) is fired. In a block 2306 of method 2300, which is executed after block 2304, phase 302(2) is fired, and in a block 2308 of method 2300, which is executed after block 2306, phase 302(5) is fired. In a block 2310 of method 2300, which is executed after block 2308, phase 302(3) is fired, and in a block 2312 of method 2300, which is executed after block 2310, phase 302(6) is fired. Method 2300 returns to block 2302 after executing block 2112.

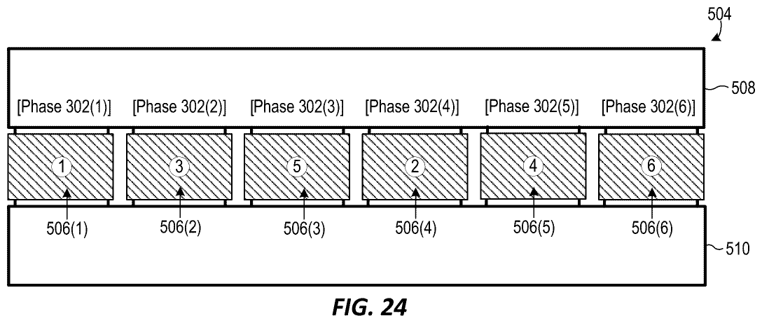

FIG. 24 is a cross-sectional view of coupled inductor 500 taken along line 8A-8A of FIG. 6 that is marked-up with (a) the respective phase 302 corresponding to each winding 506 and (b) the order of firing phases 302 according to method 2300. In particular, the number 1 in a circle indicates that phase 302(1), which includes winding 506(1), is fired first, the number 2 in a circle indicates that phase 302(4), which includes winding 506(4), is fired second, and so on. As evident from FIG. 24, phases 302 with immediately physically adjacent windings 506 are not consecutively fired, and in some cases, there are two intervening windings 506 between windings 506 that are consecutively fired. Accordingly, method 2300 reduces potential for high magnetic flux density in magnetic core 504 resulting from current of large magnitude simultaneously flowing through two windings 506 that are near each other.

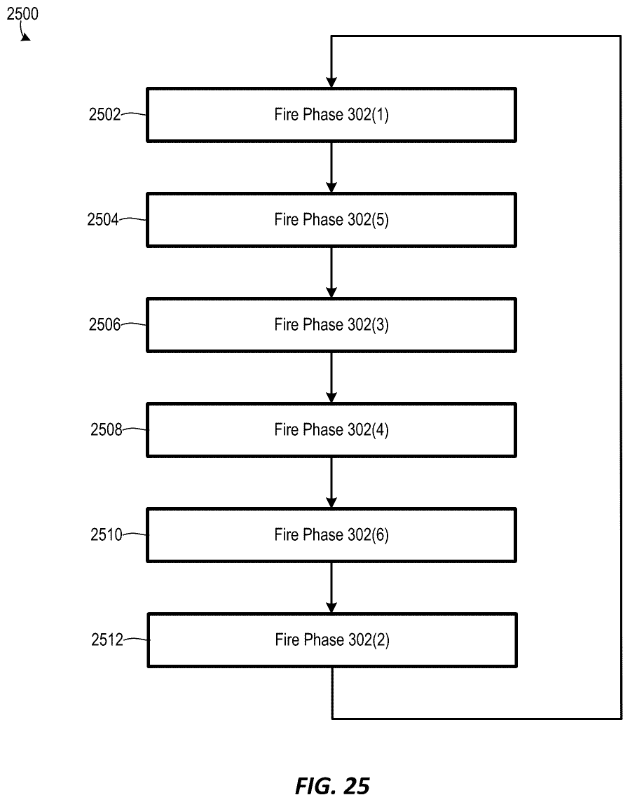

FIG. 25 is a flow chart of a method 2500 for reducing magnetic core losses in a multi-phase switching power converter including a coupled inductor, which is another example of how the new multi-phase switching power converters disclosed herein may control phases 302. Method 2500 assumes that (a) the multi-phase switching power converter is multi-phase switching power converter 900 of FIG. 9, (b) N is equal to six, and (c) coupled inductor 920 is embodied by coupled inductor 1000 of FIG. 10. Method 2500 alternately fires one phase 302 from each row of windings 1008 until all phases are fired. Specifically, in a block 2502 of method 2500, phase 302(1) is fired, and in a block 2504 of method 2500, which is executed after block 2502, phase 302(5) is fired. In a block 2506 of method 2500, which is executed after block 2504, phase 302(3) is fired, and in a block 2508 of method 2500, which is executed after block 2506, phase 302(4) is fired. In a block 2510 of method 2500, which is executed after block 2508, phase 302(6) is fired, and in a block 2512 of method 2500, which is executed after block 2510, phase 302(2) is fired. Method 2500 returns to block 2502 after executing block 2512.

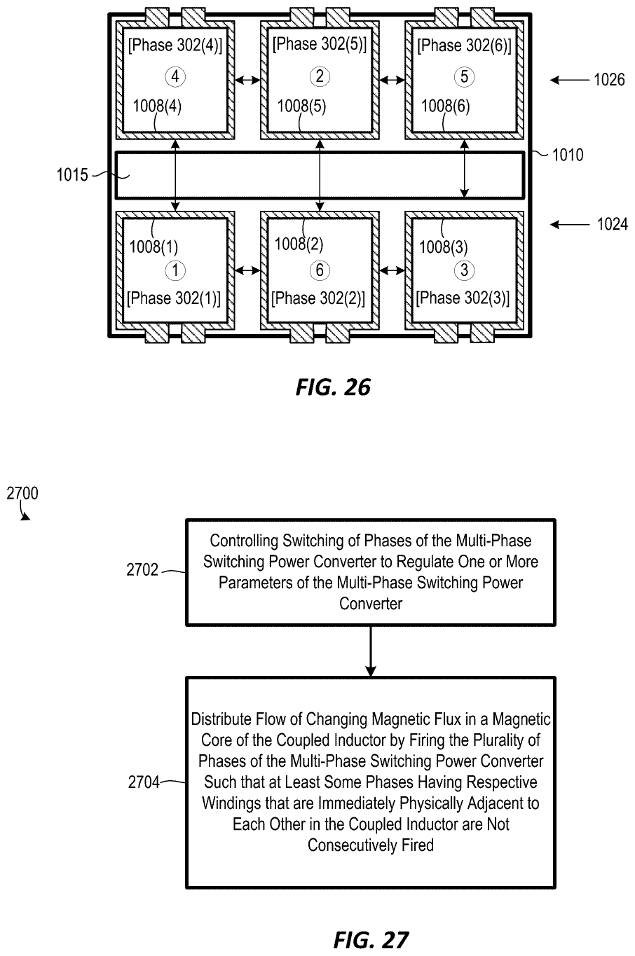

FIG. 26 is a cross-sectional view of coupled inductor 1000 that is analogous to the FIG. 13 cross-sectional view and marked-up with (a) the respective phase 302 corresponding to each winding 1008 and (b) the order of firing phases 302 according to method 2500. In particular, the number 1 in a circle indicates that phase 302(1), which includes winding 1008(1), is fired first, the number 2 in a circle indicates that phase 302(5), which includes winding 1008(5), is fired second, and so on. As evident from FIG. 26, phases 302 with immediately physically adjacent windings 1008 are not consecutively fired, and in some cases, there are multiple intervening windings 1008 between windings 1008 that are consecutively fired. Accordingly, method 2500 reduces potential for high changing magnetic flux density in magnetic core 1006 resulting from current of large magnitude simultaneously flowing through two windings 1008 that are near each other.

FIG. 27 is a flow chart of a method 2700 for reducing magnetic core losses in a multi-phase switching power converter including a coupled inductor, which is an additional example of how the new multi-phase switching power converters disclosed herein may control phases 302. In a block 2702, switching of a plurality of phase of the multi-phase switching power converter is controlled to regulate one or more parameters of the multi-phase switching power converter. In one example of block 2702, controller 304 fires phases 302 of multi-phase switching power converter 300 or 900 in a manner which controls duty cycle of phases 302 to regulate one or more of magnitude of input voltage Vᵢₙ, magnitude of input current Iᵢₙ, magnitude of output voltage Vₒ, and magnitude of output current Iₒ.

In a block 2704 of method 2700, which is executed after block 2702, flow of changing magnetic flux in a magnetic core of the coupled inductor is distributed by firing the plurality of phases of the multi-phase switching power converter such that at least some phases having respective windings that are immediately physically adjacent to each other in the coupled inductor are not consecutively fired. In one example of block 2704, controller 304 distributes flow of magnetic flux in magnetic core 318 or 918 by firing phases 302 according to the order illustrated in FIGS. 17A, 18A, and 19, or according to one of methods 2100, 2300, or 2500.

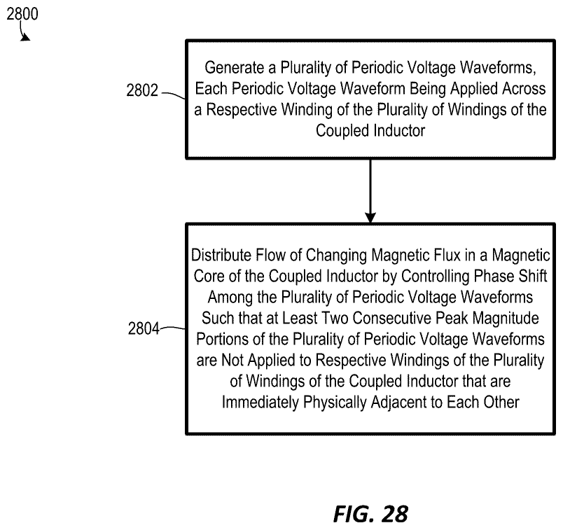

FIG. 28 is a flow chart of a method 2800 for reducing magnetic core losses in a multi-phase switching power converter including a coupled inductor, which is an additional example of how the new multi-phase switching power converters disclosed herein may control phases 302. In a block 2802 of method 2800, a plurality of periodic voltage waveforms are generated, where each periodic voltage waveform is applied across a respective winding of a plurality of windings of the coupled inductor. In one example of block 2802, controller 304 controls switching stages 308 to generate the periodic voltage waveforms V_{w} of FIG. 17A, which are applied across respective windings 310 of coupled inductor 320. In another example of block 2802, controller 304 controls switching stages 308 to generate the periodic voltage waveforms V_{w} of FIG. 18A, which are applied across respective windings 310 of coupled inductor 320.

In a block 2804 of method 2800, flow of changing magnetic flux in a magnetic core of the coupled inductor is distributed by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other. In one example of block 2804, controller 304 controls switching stages 308 such that they are fired in the order illustrated in FIG. 17A or 18A, which results in phase shift among periodic voltage waveforms V_{w} such that consecutive peak magnitude portions tₚ are not applied to immediately physically adjacent windings 310 in coupled inductor 320. In another example of block 2808, controller 304 controls switching stages 308 such that they are fired in the order according to one of methods 2100, 2300, or 2500, which also results in phase shift among periodic voltage waveforms V_{w} such that consecutive peak magnitude portions of voltage waveforms V_{w} are not applied to immediately physically adjacent windings 310 in coupled inductor 320 or 920.

Referring again to FIGS. 3 and 9, a desired order of firing phases 302 is achieved, for example, by configuring controller 304 to implement a desired order of firing phases 302 and/or by assigning control signals generated by controller 304 to phases 302 in a manner which achieves a desired order of firing phases 302. Control signals generated by controller 304 are assigned to phases 302, for example, by selective connection of output ports, e.g., electrical terminals, of controller 304 to switching stages 308.

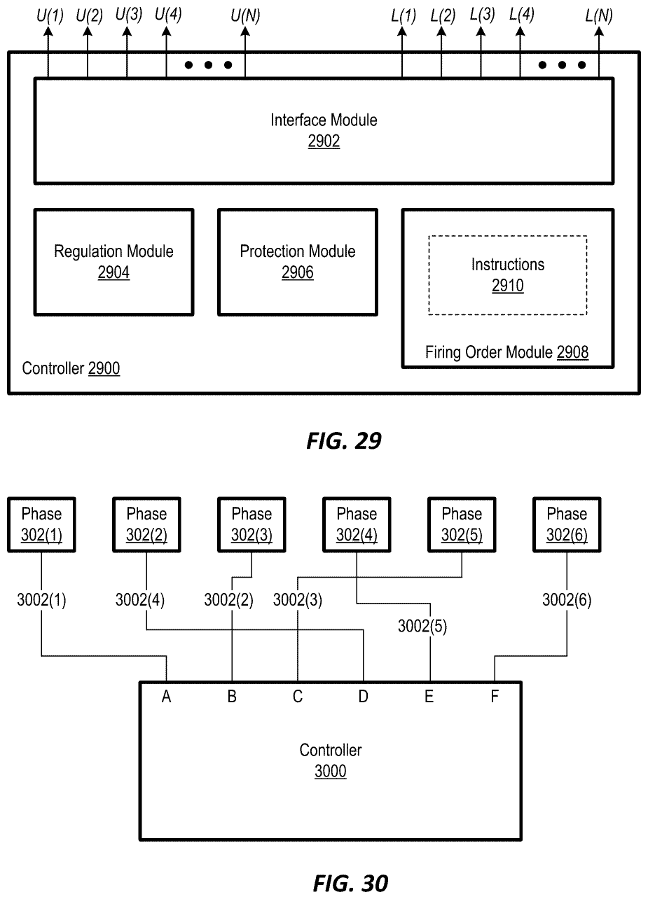

For example, FIG. 29 is a block diagram of a controller 2900, which is one possible embodiment of controller 304 that is capable of being configured to achieve a desired order of firing phases 302. Controller 2900 includes an interface module 2902, a regulation module 2904, a protection module 2906, and a firing order module 2908. The aforementioned modules 2902-2908 of controller 2900 are implemented, for example, by analog electronic circuitry and/or by digital electronic circuitry. Additionally, in some embodiments, at least part of one or more of modules 2902-2908 are implemented by a processor executing instructions, such as software and/or firmware, stored in storage device.

Interface module 2902 is configured to interface controller 2900 to one or more devices external to controller 2902. For example, FIG. 29 illustrates interface module 2902 providing an interface for control signals U and L for devices external to controller 2900, such as for switching stages 308. Interface module 2902 may also provide an interface for one or more additional signals, such as feedback signals, telemetry signals, additional control signals, etc. In some embodiments, interface module 2902 includes one or more of level shifting circuitry, isolation circuitry, signal processing circuitry, digital-to-analog conversion circuitry, and analog-to-digital conversion circuitry.

Regulation module 2904 is configured to control generation of control signals U and L to regulate one or more parameters of multi-phase switching power converter 300 or 900, such as magnitude of voltage Vᵢₙ, current Iᵢₙ, voltage Vₒ, and/or current Iₒ. Some embodiments of controller 2900 are configured to implement the aforementioned regulation using a PWM technique or a PFM technique.

Protection module 2906 is configured to cooperate with regulation module 2904 and/or interface module 2902 to implement one or more protection functions of multi-phase switching power converter 300 or 900, such as short circuit protection, over current protection, over voltage protection, soft start functionality, current sharing functionality, etc. Firing order module 2908 is configured to cooperate with regulation module 2904 and/or interface module 2902 to fire phases 302 according to instructions 2910. Instructions 2910 include, for example, instructions to fire phases 302 according to one of method 1900, method 2100, method 2300, or method 2500. In some embodiments, instructions 2910 include data stored in a memory or other data storage device. In some other embodiments, instructions 2910 include a physical arrangement of elements of controller 2900, such as a switch configuration, a jumper configuration, a fuse pattern, etc.

FIG. 30 is a block diagram illustrating one example of how a desired order of firing phases 302 may be achieved by selectively assigning control signals generated by controller 304 to phases 302, in an embodiment of multi-phase switching power converter 300 or 900 where N is equal to six. FIG. 30 includes a controller 3000, six instances of phases 302, and six logical connections 3002. Details of phases 302 are not shown in FIG. 30 for illustrative clarity. Controller 3000 is configured to generate respective control signals for each phase 302, such as control signals U and L, on each of six output ports A, B, C, D, E, and F. Stated differently, each output port A, B, C, D, E, and F provides control signals for one respective phase 302. Controller 3000 is additionally configured to generate controls signals to fire phases 302 according to the following order: (1) fire phase 302 connected to output port A, (2) fire phase 302 connected to output port B, (3) fire phase 302 connected to output port C, (4) fire phase 302 connected to output port D, (5) fire phase 302 connected to output port E, and (6) fire phase 302 connected to output port F. While the order of generation of control signals by controller 3000 is not adjustable, a desired firing order of phases 302 may nevertheless be achieved by selectively communicatively coupling output ports A-F to phases 302 via logical connections 3002. For example, the illustrated configuration of logical connections 3002 in FIG. 30 achieves the firing order of method 1900, by communicatively coupling output port A to phase 302(1), output port B to phase 302(3), and so on. Each logical connection 3002 can be, but need not be, a physical connection. Accordingly, in certain embodiments, two or more logical connections 3002 are implemented by a single physical connection, such as a single bus carrying multiple control signals.

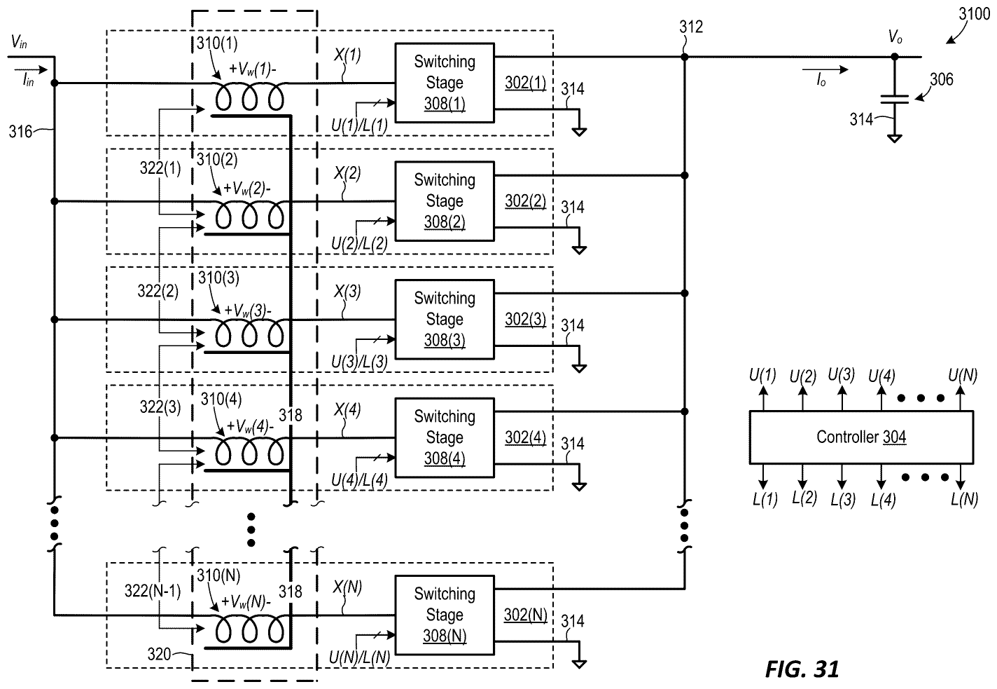

Referring again to FIGS. 3 and 9, while multi-phase switching power converters 300 and 900 have a buck topology, the new multi-phase switching power converters disclosed herein are not limited to having a buck topology. Instead, the new multi-phase switching power converters can have essentially any topology, including but not limited to a boost topology or a buck-boost topology, that is compatible with a coupled inductor and is capable of applying a respective voltage waveform, e.g., square wave voltage waveform, across each winding of the coupled inductor. Such topologies can also be modified to be multi-level or/and isolated topologies compatible with a coupled inductor. For example, FIG. 31 is a schematic diagram of a multi-phase switching power converter 3100, which is an alternate embodiment of multi-phase switching power converter 300 that is modified to have a boost topology. Each switching stage 308 is configured to switch its respective switching node X between reference node 314 and output power node 312 in response to control signals U and L to generate a respective voltage waveform V_{w} across its respective winding 310. Accordingly, a given phase 302 of multi-phase switching power converter 3100 is fired by its respective switching stage 308 connecting its respective switching node X to reference node 314, e.g., by the switching stage 308 changing its operating state so that the switching node X is connected to reference node 314 instead of being connected to output power node 312.

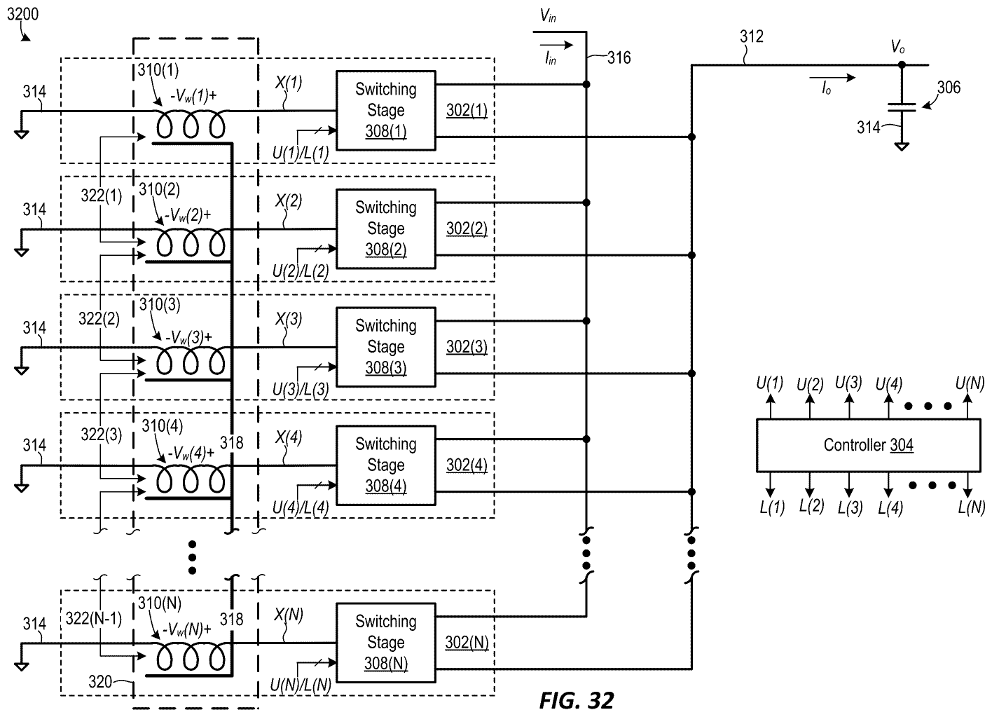

As another example, FIG. 32 is a schematic diagram of a multi-phase switching power converter 3200, which is an alternate embodiment of multi-phase switching power converter 300 modified to have a buck-boost topology. Each switching stage 308 is configured to switch its respective switching node X between input power node 316 and output power node 312 in response to control signals U and L to generate a respective voltage waveform V_{w} across its respective winding 310. Accordingly, a given phase 302 of multi-phase switching power converter 3200 is fired by its respective switching stage 308 connecting its respective switching node X to input power node 316, e.g., by the switching stage 308 changing its operating state so that the switching node X is connected to input power node 316 instead of being connected to output power node 312.

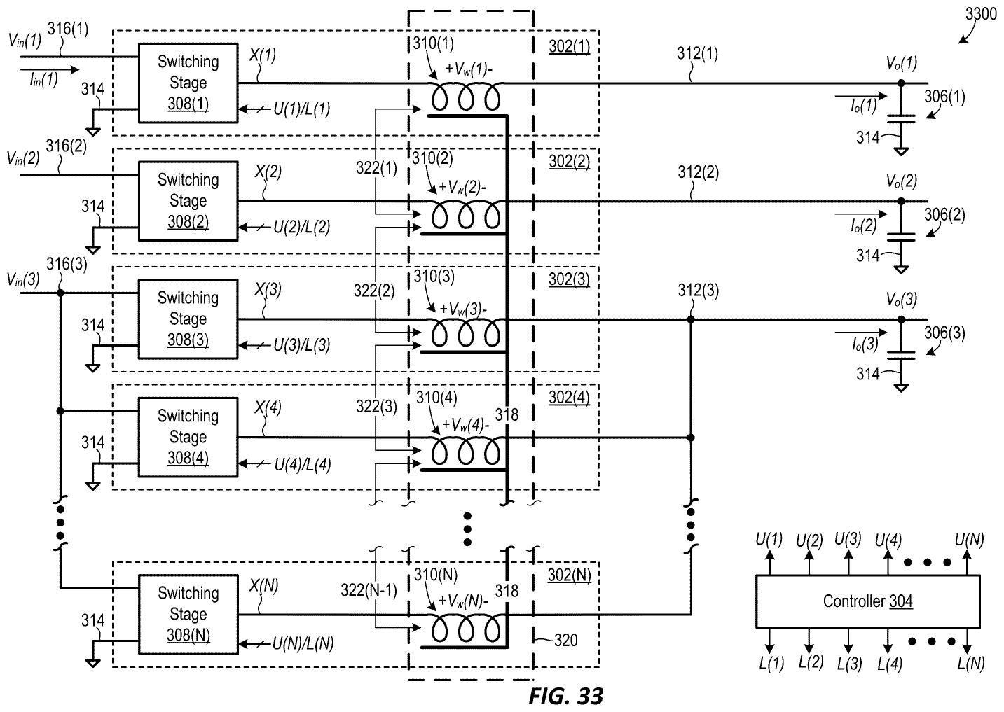

The multi-phase switching power converters disclosed herein could be configured to receive power from a plurality of input power nodes, and/or to provide output power to a plurality of output power nodes, without departing from the scope hereof. For example, FIG. 33 is a schematic diagram of a multi-phase switching power converter 3300, which is an alternate embodiment of switching power converter 300 that is configured to (a) receive power from three input power nodes 316(1), 316(2), and 316(3), and (b) provide power to three output power nodes 312(1), 312(2), and 312(3). In particular, phase 302(1) is configured to receive power from input power node 316(1) and provide power to output power node 312(1), and phase 302(2) is configured to receive power from input power node 316(2) and provide power to output power node 312(2). Additionally, phases 302(3)-302(N) are configured to receive power from input power node 316(3) and provide power to output power node 312(3). In some embodiments, two or more of input power nodes 316(1), 316(2), and 316(3) are at a different electrical potential with respect to reference node 314. Additionally, in certain embodiments, two or more of output power node 312(1), output power node 312(2), and output power node 312(3) are at a different electrical potential with respect to reference node 314. The number of input power nodes 316, the number of output power nodes 312, and the particular phases 302 connected to each input power node 316 and each output power node 312 could differ without departing from the scope hereof.

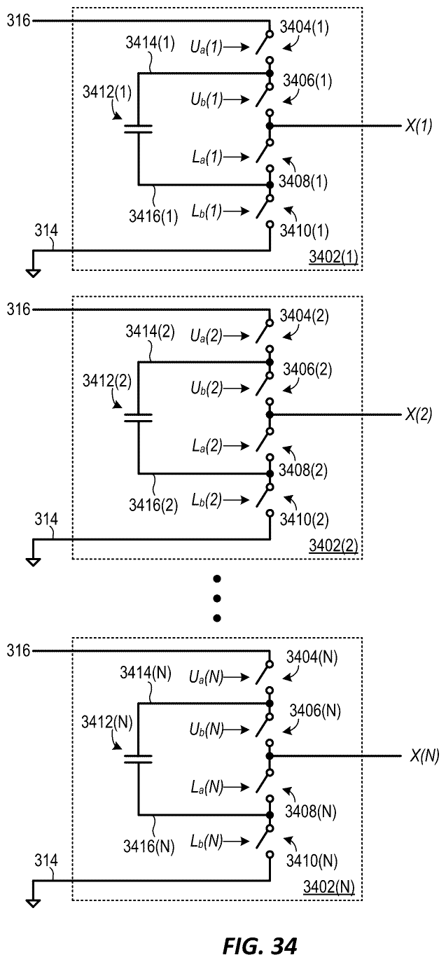

The multi-phase switching power converters disclosed herein could also be configured as multi-level switching power converters, i.e., switching power converters having three or more levels. For example, switching stages 308 of multi-phase switching power converter 300 could be configured as shown in FIG. 34 so that multi-phase switching power converter 300 is a three level switching power converter instead of a two level switching power converter. FIG. 34 is a schematic diagram of N switching stages 3402, where switching stages 3402 are another embodiment of switching stages 308 of FIG. 3. Each switching stage 3402 includes a first upper switching device 3404, a second upper switching device 3406, a first lower switching device 3408, a second lower switching device 3410, and a flying capacitor 3412. Each first upper switching device 3404 and each second upper switching device 3406 are electrically coupled in series between input power node 316 and the switching node X of its respective phase 302. Each first lower switching device 3408 and each second lower switching device 3410 are electrically coupled in series between the switching node X of its respective phase 302 and reference node 314. Within each switching stage 3402, flying capacitor 3412 is electrically coupled between (a) a first capacitor node 3414 joining first upper switching device 3404 and second upper switching device 3406 and (b) a second capacitor node 3416 joining first lower switching device 3408 and second lower switching device 3110.

In embodiments where switching stages 308 are embodied according to FIG. 34, controller 304 is modified to generate the following four control signals for each switching stage 3402: (a) a control signal Uₐ, (b) a control signal U_{b}, (c) a control signal Lₐ, and (d) a control signal L_{b}. Each first upper switching device 3404 switches in response to a respective control signal Uₐ from controller 304, and each second upper switching device 3406 switches in response to a respective control signal U_{b} generated by controller 304. Each first lower switching device 3408 switches in response to a respective control signal Lₐ from controller 304, and each second lower switching device 3410 switches in response to a respective control signal L_{b} from controller 304. Each switching device 3404, 3406, 3408, and 3410 includes, for example, one or more transistors.

In particular embodiments, controller 304 is configured to (a) generate control signals Uₐ and U_{b} for a given switching stage 3402 such that first upper switching device 3404 and second upper switching device 3406 of the switching stage switch out of phase with respect to each other, (b) generate control signals Uₐ and U_{b} to control duty cycle of first upper switching devices 3404 and second upper switching devices 3406 to regulate one or more parameters of multi-phase switching power converter 300, such as using a PWM or PFM technique, and (c) for each switching stage 3402, generate control signals Lₐ and L_{b} such that second lower switching device 3410 performs a freewheeling function for first upper switching device 3404, and such that first lower switching device 3408 performs a freewheeling function for second upper switching device 3406. Switching stages 3402 could be modified to support additional switching power converter levels, such as by adding one or more additional sets of an upper switching device, a lower switching device, and a flying capacitor.

### Combinations of Features

Features described above may be combined in various ways without departing from the scope hereof. The following examples illustrate some possible combinations.

(A1) A method for reducing magnetic core losses in a multi-phase switching power converter including a coupled inductor includes (1) generating a plurality of periodic voltage waveforms, each periodic voltage waveform being applied across a respective winding of a plurality of windings of the coupled inductor, and (2) distributing flow of changing magnetic flux in a magnetic core of the coupled inductor by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other.

(A2) In the method denoted as (A1), each periodic voltage waveform may be a respective square wave voltage waveform.

(A3) In either one of the methods denoted as (A1) and (A2), (1) a first phase of the plurality of phases of the multi-phase switching power converter may include a first winding of the plurality of windings of coupled inductor, (2) a second phase of the plurality of phases of the multi-phase switching power converter may include a second winding of the plurality of windings of coupled inductor, (3) an additional phase of the plurality of phases of the multi-phase switching power converter may include an additional winding of the plurality of windings of coupled inductor, (4) the first winding may be further away from the additional winding than from the second winding, and (5) controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other may include (i) firing the first phase and (ii) after firing the first phase, but before firing the second phase, firing the additional phase.

(A4) In the method denoted as (A3), the second winding may be located between the first winding and the additional winding, in the coupled inductor.

(A5) In either one of the methods denoted as (A3) or (A4), the first winding, the second winding, and the additional winding may be located within a common row of the coupled inductor.

(A6) In either one of the methods denoted as (A3) or (A4), at least two of the first winding, the second winding, and the additional winding may be located within different respective rows of the coupled inductor.

(A7) In any one of the methods denoted as (A3) through (A6), a magnetic core of the coupled inductor may include a plurality of winding posts, and each of the first winding, the second winding, and the additional winding may be at least partially wound around a respective winding post of the plurality of winding posts.

(A8) In any one of the methods denoted as (A3) through (A7), (1) firing the first phase may include electrically connecting a switching node of the first phase to a first power node, (2) firing the second phase may include electrically connecting a switching node of the second phase to the first power node, and (3) firing the additional phase may include electrically connecting a switching node of the additional phase to the first power node.

(A9) In any one of the methods denoted as (A3) through (A7), (1) firing the first phase may include electrically connecting a switching node of the first phase to a first power node, (2) firing the second phase may include electrically connecting a switching node of the second phase to a second power node, and (3) firing the additional phase may include electrically connecting a switching node of the additional phase to an additional power node.

(A10) In the method denoted as (A9), at least two of the first power node, the second power node, and the additional power node may be at different respective electrical potentials with respect to a reference node.

(A11) In any one of the methods denoted as (A3) through (A7), (1) firing the first phase may include switching a switching node of the first phase from a reference node to a first power node, (2) firing the second phase may include switching a switching node of the second phase from the reference node to the first power node, and (3) firing the additional phase may include switching a switching node of the additional phase from the reference node to the first power node.

(A12) In any one of the methods denoted as (A3) through (A7), (1) firing the first phase may include switching a switching node of the first phase from a reference node to a first power node, (2) firing the second phase may include switching a switching node of the second phase from the reference node to a second power node, and (3) firing the additional phase may include switching a switching node of the additional phase from the reference node to an additional power node.

(A13) In the method denoted as (A12), at least two of the first power node, the second power node, and the additional power node may be at different respective electrical potentials with respect to the reference node.

(A14) In any one of the methods denoted as (A3) through (A13), the first winding may be further away from the additional winding than from a third winding of the plurality of windings of the coupled inductor, and the third winding may be part of a third phase of the plurality of phases of the multi-phase switching power converter.

(A15) In any one of the methods denoted as (A3) through (A14), at least two windings of the plurality of windings of the coupled inductor may share one or more leakage magnetic flux transmission elements of the magnetic core of the coupled inductor.

(A16) Any one of the methods denoted as (A1) through (A15) may further include controlling switching of the plurality of phases of the multi-phase switching power converter to regulate one or more parameters of the multi-phase switching power converter.

(A17) In the method denoted as (A16), the one or more parameters of the multi-phase switching power converter may include at least one of (a) a magnitude of a voltage of the multi-phase switching power converter and (b) a magnitude of a current of the multi-phase switching power converter.

(A18) In any one of the methods denoted as (A1) through (A17), the multi-phase switching power converter may be selected from the group consisting of a buck multi-phase switching power converter, a boost multi-phase switching power converter, and a buck-boost multi-phase switching power converter.

(B1) A multi-phase switching power converter includes (1) a coupled inductor including a plurality of windings and a magnetic core, each winding of the plurality of windings being part of a respective phase of a plurality of phases of the multi-phase switching power converter, (2) a plurality of switching stages, each switching stage of the plurality of switching stages being part of a respective phase of the plurality of phases of the multi-phase switching power converter, and (3) a controller configured to (i) control the plurality of switching stages to generate a plurality of periodic voltage waveforms, each periodic voltage waveform being applied across a respective winding of the plurality of windings of the coupled inductor, and (ii) cause changing magnetic flux to be distributed within the magnetic core of the coupled inductor by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other.

(B2) In the multi-phase switching power converter denoted as (B1), the plurality of windings of the coupled inductor may be within a common row of the coupled inductor.

(B3) In the multi-phase switching power converter denoted as (B1), at least two windings of the plurality of windings of the coupled inductor may be within different respective rows of the coupled inductor.

(B4) In any one of the multi-phase switching power converters denoted as (B1) through (B3), at least two windings of the plurality of windings of the coupled inductor may share one or more leakage magnetic flux transmission elements of the magnetic core of the coupled inductor.

(C1) A method for reducing magnetic core losses in a multi-phase switching power converter including a coupled inductor includes (1) controlling switching of a plurality of phases of the multi-phase switching power converter to regulate one or more parameters of the multi-phase switching power converter and (2) distributing flow of changing magnetic flux in a magnetic core of the coupled inductor by firing the plurality of phases of the multi-phase switching power converter such that at least some phases having respective windings that are immediately physically adjacent to each other in the coupled inductor are not consecutively fired.

(C2) In the method denoted as (C1), the multi-phase switching power converter may be selected from the group consisting of a buck multi-phase switching power converter, a boost multi-phase switching power converter, and a buck-boost multi-phase switching power converter.

(C3) In either one of the methods denoted as (C1) or (C2), the one or more parameters of the multi-phase switching power converter may include at least one of (a) a magnitude of a voltage of the multi-phase switching power converter and (b) a magnitude of a current of the multi-phase switching power converter.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for reducing magnetic core losses in a multi-phase switching power converter including a coupled inductor, the method comprising:
generating a plurality of periodic voltage waveforms, each periodic voltage waveform being applied across a respective winding of a plurality of windings of the coupled inductor; and
distributing flow of changing magnetic flux in a magnetic core of the coupled inductor by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other.

2. The method of claim 1, wherein each periodic voltage waveform is a respective square wave voltage waveform.

3. The method of claim 1, wherein:
a first phase of the plurality of phases of the multi-phase switching power converter includes a first winding of the plurality of windings of coupled inductor;
a second phase of the plurality of phases of the multi-phase switching power converter includes a second winding of the plurality of windings of coupled inductor;
an additional phase of the plurality of phases of the multi-phase switching power converter includes an additional winding of the plurality of windings of coupled inductor;
the first winding is further away from the additional winding than from the second winding; and
controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other comprises:
firing the first phase; and
after firing the first phase, but before firing the second phase, firing the additional phase.

4. The method of claim 3, wherein the second winding is located between the first winding and the additional winding, in the coupled inductor.

5. The method of claim 3, wherein the first winding, the second winding, and the additional winding are located within a common row of the coupled inductor.

6. The method of claim 3, wherein at least two of the first winding, the second winding, and the additional winding are located within different respective rows of the coupled inductor.

7. The method of claim 3, wherein:
a magnetic core of the coupled inductor comprises a plurality of winding posts; and
each of the first winding, the second winding, and the additional winding is at least partially wound around a respective winding post of the plurality of winding posts.

8. The method of claim 3, wherein:
firing the first phase comprises electrically connecting a switching node of the first phase to a first power node;
firing the second phase comprises electrically connecting a switching node of the second phase to the first power node; and
firing the additional phase comprises electrically connecting a switching node of the additional phase to the first power node.

9. The method of claim 3, wherein:
firing the first phase comprises electrically connecting a switching node of the first phase to a first power node;
firing the second phase comprises electrically connecting a switching node of the second phase to a second power node; and
firing the additional phase comprises electrically connecting a switching node of the additional phase to an additional power node.

10. The method of claim 9, wherein at least two of the first power node, the second power node, and the additional power node are at different respective electrical potentials with respect to a reference node.

11. The method of claim 3, wherein:
firing the first phase comprises switching a switching node of the first phase from a reference node to a first power node;
firing the second phase comprises switching a switching node of the second phase from the reference node to the first power node; and
firing the additional phase comprises switching a switching node of the additional phase from the reference node to the first power node.

12. The method of claim 3, wherein:
firing the first phase comprises switching a switching node of the first phase from a reference node to a first power node;
firing the second phase comprises switching a switching node of the second phase from the reference node to a second power node; and
firing the additional phase comprises switching a switching node of the additional phase from the reference node to an additional power node.

13. The method of claim 12, wherein at least two of the first power node, the second power node, and the additional power node are at different respective electrical potentials with respect to the reference node.

14. The method of claim 3, wherein the first winding is further away from the additional winding than from a third winding of the plurality of windings of the coupled inductor, the third winding being part of a third phase of the plurality of phases of the multi-phase switching power converter.

15. The method of claim 1, wherein at least two windings of the plurality of windings of the coupled inductor share one or more leakage magnetic flux transmission elements of the magnetic core of the coupled inductor.

16. The method of claim 1, further comprising controlling switching of the plurality of phases of the multi-phase switching power converter to regulate one or more parameters of the multi-phase switching power converter.

17. A multi-phase switching power converter, comprising:
a coupled inductor including a plurality of windings and a magnetic core, each winding of the plurality of windings being part of a respective phase of a plurality of phases of the multi-phase switching power converter;
a plurality of switching stages, each switching stage of the plurality of switching stages being part of a respective phase of the plurality of phases of the multi-phase switching power converter; and
a controller configured to:
control the plurality of switching stages to generate a plurality of periodic voltage waveforms, each periodic voltage waveform being applied across a respective winding of the plurality of windings of the coupled inductor, and
cause changing magnetic flux to be distributed within the magnetic core of the coupled inductor by controlling phase shift among the plurality of periodic voltage waveforms such that at least two consecutive peak magnitude portions of the plurality of periodic voltage waveforms are not applied to respective windings of the plurality of windings of the coupled inductor that are immediately physically adjacent to each other.

18. The multi-phase switching power converter of claim 17, wherein at least two windings of the plurality of windings of the coupled inductor share one or more leakage magnetic flux transmission elements of the magnetic core of the coupled inductor.

19. A method for reducing magnetic core losses in a multi-phase switching power converter including a coupled inductor, the method comprising:
controlling switching of a plurality of phases of the multi-phase switching power converter to regulate one or more parameters of the multi-phase switching power converter; and
distributing flow of changing magnetic flux in a magnetic core of the coupled inductor by firing the plurality of phases of the multi-phase switching power converter such that at least some phases having respective windings that are immediately physically adjacent to each other in the coupled inductor are not consecutively fired.

20. The method of claim 19, wherein:
the multi-phase switching power converter is selected from the group consisting of a buck multi-phase switching power converter, a boost multi-phase switching power converter, and a buck-boost multi-phase switching power converter; and
the one or more parameters of the multi-phase switching power converter comprise at least one of (a) a magnitude of a voltage of the multi-phase switching power converter and (b) a magnitude of a current of the multi-phase switching power converter.
